(19) United States
(12) Patent Application Publication
(10) Pub. No.: US 2020/0281225 A1
(43) Pub. Date: Sep. 10, 2020

(54) FEED ADDITIVE COMPOSITION

(71) Applicant: DUPONT NUTRITION BIOSCIENCES APS, Copenhagen K (DK)

(72) Inventors: Elijah G. Kiarie, Guelph (CA); Luis Fernando Romero Millan, Wiltshire (GB); Laura Payling, Gloucestershire (GB); Maria Walsh, Wiltshire (GB); Susan Arent Lund, Brabrand (DK)

(21) Appl. No.: 15/773,363

(22) PCT Filed: Nov. 4, 2016
(86) PCT No.: PCT/US2016/060607

§ 371 Date: May 3, 2018

Related U.S. Application Data
(60) Provisional application No. 62/253,089, filed on Nov. 9, 2015.

(51) Int. Cl. A23K 10/18; A23K 20/189; A23K 20/174; A23K 50/30

(52) U.S. Cl. CPC A23K 10/18; A23K 20/189; C12Y 304/21062; A23K 50/30; A23K 20/174

(57) ABSTRACT

Disclosed is feed additive composition consisting essentially of a direct fed microbial comprising one or more bacterial strains in combination with at least one protease and a method for improving the performance of a subject or for improving digestibility of a raw material in a feed, which method comprising administering to a subject a direct fed microbial in combination with a protease.

This application claims the benefit of U.S. Provisional Application No. 62/253,089 filed Nov. 9, 2015, which is incorporated herein by reference in its entirety.

### FIELD

The field relates to a feed additive composition for comprising a direct-fed microbial comprising one or more bacterial strains in combination with one or more proteases as well as methods, kits and uses thereof.

### BACKGROUND

Direct-fed microbials (DFM) or probiotics are dietary supplements that inhibit gastrointestinal infection and provide optimally regulated microbial environments in the digestive tract. Concern over the use of antibiotics in the animal feed industry has led to the exploration of alternatives to prevent disease. DFMs can be used as antimicrobial replacements and, thus, reduce the need for antibiotics in animal feed. DFMs may also compete with and inhibit the growth of pathogens, stimulate immune function and modulate microbial balance in the gastronintestinal tract. DFMs include direct-fed bacteria and yeast-based products. It has been found that the combination of DFMs with one or more enzymes can improve nutrient utilization production performance characteristics in animals.

U.S. Patent Publication 2013/0330307, published Dec. 12, 2013, discloses a feed additive composition comprising a direct fed microbial in combination with a protease and a phytase as well as a method to improve production performance characteristics in animals.

U.S. Patent Publication 2014/0234279, published Aug. 21, 2014, discloses discloses a feed additive composition comprising a direct fed microbial in combination with a protease, a xylanase, an amylase and a phytase as well as a method to improve production performance characteristics in animals.

U.S. Pat. No. 8,722,058, issued to Rehberger et al. on May 13, 2014, describes a method of feeding an animal one or more Bacillus strains selected from the group consisting of 3A-P4 ATCC PTA-6506, 15A-P4 ATTC PTA-6507 and 22C-P1 ATCC PTA-6508.

### SUMMARY

In one aspect, what is disclosed is a feed additive composition consisting essentially of a direct fed microbial comprising one or more bacterial strains in combination with at least one protease.

In a second aspect, the direct-fed microbial is an antipathogen direct-fed microbial.

In a third aspect, the direct-fed microbial comprises at least three bacterial strains selected from the group consisting of: Lactobacillus, Lactococcus, Streptococcus, Bacillus, Pediococcus, Enterococcus, Leuconostoc, Carnobacterium, Propionibacterium, Bifidobacterium, Clostridium and Megasphaera and combinations thereof.

In a fourth aspect, the direct-fed microbial comprises at least three bacterial strains selected from the group consisting of: Bacillus subtilis, Bacillus licheniformis, Bacillus pumilus, Bacillus amyloliquefaciens, Enterococcus, Enterococcus spp, and Pediococcus spp, Lactobacillus spp, Bifidobacterium spp, Lactobacillus acidophilus, Pediococsus acidilactici, Lactococcus lactis, Bifidobacterium bifidum, Propionibacterium thoenii, Lactobacillus farciminus, Lactobacillus rhamnosus, Clostridium butyricum, Bifidobacterium animalis ssp. animalis, Lactobacillus reuteri, Bacillus cereus, Lactobacillus salivarius ssp. salivarius, Megasphaera elsdenii, Propionibacteria sp and combinations thereof.

In a fifth aspect, the direct-fed microbial comprises Bacillus subtilis strains 3BP5 (NRRL B-50510); 918 (NRRL B-50508), and 1013 (NRRL B-50509).

In a sixth aspect, the direct-fed microbial can be in the form of an endospore.

In a seventh aspect, the feed additive composition also comprises at least one protease that is a subtilisin, a bacillolysin, an alkaline serine protease, a keratinase or a Nocardiopsis protease.

In an eighth aspect, at least one protease is a subtilisin from Bacillus amyloliquefaciens.

In a ninth aspect, at least one protease in the feed additive composition is present at a dosage of 1000 PU/g feed additive composition to 200,000 PU/g feed additive composition.

In a tenth aspect, the DFM in the feed additive composition is present at a dosage of 1×10³ CFU/g feed additive composition to 1×10¹³ CFU/g feed additive composition.

In an eleventh aspect, disclosed is a method for improving the performance of a subject or for improving digestibility of a raw material in a feed (e.g. nutrient digestibility, such as amino acid digestibility), or for improving nitrogen retention, or for improving the subjects resistance to necrotic enteritis or for improving feed conversion ratio (FCR) or for increasing the carcass or meat yield or for improving body weight gain in a subject or for improving feed efficiency in a subject or for modulating (e.g. improving) the immune response of the subject, or for promoting the growth of beneficial bacteria in the gastrointestinal tract of a subject or for reducing populations of pathogenic bacteria in the gastrointestinal tract of a subject, or for reducing nutrient excretion in manure, or for reducing the production of ammonia in manure, or for improving the digestibility or utilization of dietary hemicellulose or fibre, which method comprising administering a direct-fed microbial comprising one or more bacterial strains in combination with at least one protease.

In a twelfth aspect, disclosed is a kit comprising any of the feed additive compositions described herein and instructions for administration.

In a thirteenth aspect, disclosed is a method of preparing a feed additive composition, comprising admixing a direct-fed microbial comprising one or more bacterial strains in combination with at least one protease and packaging.

In a fourteenth aspect, disclosed is a feed comprising any of the feed additive compositions described herein.

In a fifteenth aspect disclosed is a premix comprising any of the feed additive compositions described herein and at least one mineral and/or at least one vitamin.

### BRIEF DESCRIPTION OF THE DRAWINGS

FIG. 1 shows the effects of a three-strain Bacillus based direct-fed microbial (Bacillus strains 3BP5, 918, 1013) and Protease (P3000) when fed singly or in combination on pig growth performance.

FIG. 2 shows the effects of a three-strain Bacillus based direct-fed microbial (Bacillus strains 3BP5, 918, 1013) and Protease when fed singly or in combination on pig growth performance.

FIG. 3 shows the effects of a three-strain Bacillus based direct-fed microbial (Bacillus strains 3BP5, 918, 1013) and Protease when fed singly or in combination on on the fecal ammonia emissions.

FIG. 4 shows the effects of a three-strain Bacillus based direct-fed microbial (Bacillus strains 3BP5, 918, 1013) and Protease when fed singly or in combination on pig growth performance.

FIG. 5 shows the effects of a three-strain Bacillus based direct-fed microbial (Bacillus strains 3BP5, 918, 1013) and Protease when fed singly or in combination on the fecal ammonia concentration.

FIG. 6 shows the effects of a three-strain Bacillus based direct-fed microbial (Bacillus strains 3BP5, 918, 1013) and Protease when fed in combination or DFM alone on pig growth performance.

FIG. 7 shows the effects of a three-strain Bacillus based direct-fed microbial (Bacillus strains 3BP5, 918, 1013) and Protease when fed singly or in combination on pig growth performance.

FIG. 8.1 show the effects of a 3-strain Bacillus DFM in combination with a protease on in-vitro protein solubilisation from the ileal digesta of pigs fed a soybean meal based diet.

FIG. 8.2 shows the effects of a single strain of Bacillus licheniformis DFM in combination with a protease on in-vitro protein solubilisation from the ileal digesta of pigs fed a soybean meal based diet.

FIG. 8.3 shows the effects of a single strain of Bacillus pumilis DFM in combination with a protease on in-vitro protein solubilisation from the ileal digesta of pigs fed a soybean meal based diet.

FIG. 8.4 shows the effects of a single strain of Bacillus pumilis DFM in combination with a protease on in-vitro protein solubilisation from the ileal digesta of pigs fed a wheat based diet.

FIG. 8.5 shows the effects of a single strain of Bacillus licheniformis DFM in combination with a protease on in-vitro protein solubilisation from the ileal digesta of pigs fed a wheat based diet.

FIG. 8.6 shows the effects of a single strain of Lactobacillus reuteri DFM in combination with a protease on in-vitro protein solubilisation from the ileal digesta of pigs fed a wheat based diet.

### DETAILED DESCRIPTION

All patents, patent applications, and publications cited are incorporated herein by reference in their entirety.

In this disclosure, a number of terms and abbreviations are used. The following definitions apply unless specifically stated otherwise.

The articles “a”, “an”, and “the” preceding an element or component are intended to be nonrestrictive regarding the number of instances (i.e., occurrences) of the element or component. Therefore “a”, “an”, and “the” should be read to include one or at least one, and the singular word form of the element or component also includes the plural unless the number is obviously meant to be singular.

The term “comprising” means the presence of the stated features, integers, steps, or components as referred to in the embodiments, but that it does not preclude the presence or addition of one or more other features, integers, steps, components or groups thereof. The term “comprising” is intended to include embodiments encompassed by the terms “consisting essentially of” and “consisting of”. Similarly, the term “consisting essentially of” is intended to include embodiments encompassed by the term “consisting of”.

Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, and the like.

As used herein in connection with a numerical value, the term “about” refers to a range of +/−0.5 of the numerical value, unless the term is otherwise specifically defined in context. For instance, the phrase a “pH value of about 6” refers to pH values of from 5.5 to 6.5, unless the pH value is specifically defined otherwise.

It is intended that every maximum numerical limitation given throughout this Specification includes every lower numerical limitation, as if such lower numerical limitations were expressly written herein. Every minimum numerical limitation given throughout this Specification will include every higher numerical limitation, as if such higher numerical limitations were expressly written herein. Every numerical range given throughout this Specification will include every narrower numerical range that falls within such broader numerical range, as if such narrower numerical ranges were all expressly written herein.

The terms “animal” and “subject” are used interchangeably herein. An animal includes all non-ruminant (including humans) and ruminant animals. In a particular embodiment, the animal is a non-ruminant animal, such as a horse and a mono-gastric animal. Examples of mono-gastric animals include, but are not limited to, pigs and swine, such as piglets, growing pigs, sows; poultry such as turkeys, ducks, chicken, broiler chicks, layers; fish such as salmon, trout, tilapia, catfish and carps; and crustaceans such as shrimps and prawns. In a further embodiment the animal is a ruminant animal including, but not limited to, cattle, young calves, goats, sheep, giraffes, bison, moose, elk, yaks, water buffalo, deer, camels, alpacas, llamas, antelope, pronghorn and nilgai.

The term “pathogen” as used herein means any causative agent of disease. Such causative agents can include, but are not limited to, bacterial, viral, fungal causative agents and the like.

A “feed” and a “food,” respectively, means any natural or artificial diet, meal or the like or components of such meals intended or suitable for being eaten, taken in, digested, by a non-human animal and a human being, respectively.

As used herein, the term “food” is used in a broad sense and covers food and food products for humans as well as food for non-human animals (i.e. a feed).

The term “feed” is used with reference to products that are fed to animals in the rearing of livestock. The terms “feed” and “animal feed” are used interchangeably.

The term “direct-fed microbial” (“DFM”) as used herein is source of live (viable) naturally occurring microorganisms. A DFM can comprise one or more of such naturally occurring microorganisms such as bacterial strains. Categories of DFMs include Bacillus, Lactic Acid Bacteria and Yeasts. Bacilli are unique, gram-positive rods that form spores. These spores are very stable and can withstand environmental conditions such as heat, moisture and a range of pH. These spores germinate into active vegetative cells when ingested by an animal and can be used in meal and pelleted diets. Lactic Acid Bacteria are gram-positive cocci that produce lactic acid which are antagonistic to pathogens. Since Lactic Acid Bacteria appear to be somewhat heat-sensitive, they are not used in pelleted diets. Types of Lactic Acid Bacteria include Bifidobacterium, Lactobacillus and Streptococcus. Yeasts are not bacteria. These microorganisms belong to the plant group fungi. Thus, the term DFM encompasses one or more of the following: direct fed bacteria, direct fed yeast, direct fed yeast and combinations thereof.

The term “prebiotic” means a non-digestible food ingredient that beneficially affects the host by selectively stimulating the growth and/or the activity of one or a limited number of beneficial bacteria.

The term “probiotic culture” as used herein defines live microorganisms (including bacteria or yeasts for example) which, when for example ingested or locally applied in sufficient numbers, beneficially affects the host organism, i.e. by conferring one or more demonstrable health benefits on the host organism. Probiotics may improve the microbial balance in one or more mucosal surfaces. For example, the mucosal surface may be the intestine, the urinary tract, the respiratory tract or the skin. The term “probiotic” as used herein also encompasses live microorganisms that can stimulate the beneficial branches of the immune system and at the same time decrease the inflammatory reactions in a mucosal surface, for example the gut. Whilst there are no lower or upper limits for probiotic intake, it has been suggested that at least 10⁶-10¹², preferably at least 10⁶-10¹⁰, preferably 10⁸-10⁹, cfu as a daily dose will be effective to achieve the beneficial health effects in a subject.

The term “CFU” as used herein means “colony forming units” and is a measure of viable cells in which a colony represents an aggregate of cells derived from a single progenitor cell.

The term “protease” as used herein refers to an enzyme capable of cleaving a peptide bond. The terms “protease”, “peptidase” and “proteinase” can be used interchangeably. Proteases can be found in animals, plants, bacteria, archaea and viruses. Proteolysis can be achieved by enzymes currently classified into six broad groups: aspartic proteases, cysteine proteases, serine proteases, threonine proteases, glutamic proteases, and metalloproteases.

The term “isolated” means a substance in a form or environment that does not occur in nature. Non-limiting examples of isolated substances include (1) any non-naturally occurring substance, (2) any substance including, but not limited to, any host cell, enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated. The terms “isolated nucleic acid molecule”, “isolated polynucleotide”, and “isolated nucleic acid fragment” will be used interchangeably and refer to a polymer of RNA or DNA that is single- or double-stranded, optionally containing synthetic, non-natural or altered nucleotide bases. An isolated nucleic acid molecule in the form of a polymer of DNA may be comprised of one or more segments of cDNA, genomic DNA or synthetic DNA.

The term “purified” as applied to nucleic acids or polypeptides generally denotes a nucleic acid or polypeptide that is essentially free from other components as determined by analytical techniques well known in the art (e.g., a purified polypeptide or polynucleotide forms a discrete band in an electrophoretic gel, chromatographic eluate, and/or a media subjected to density gradient centrifugation). For example, a nucleic acid or polypeptide that gives rise to essentially one band in an electrophoretic gel is “purified.” A purified nucleic acid or polypeptide is at least about 50% pure, usually at least about 60%, about 65%, about 70%, about 75%, about 80%, about 85%, about 90%, about 91%, about 92%, about 93%, about 94%, about 95%, about 96%, about 9′7%, about 98%, about 99%, about 99.5%, about 99.6%, about 99.7%, about 99.8% or more pure (e.g., percent by weight on a molar basis). In a related sense, a composition is enriched for a molecule when there is a substantial increase in the concentration of the molecule after application of a purification or enrichment technique. The term “enriched” refers to a compound, polypeptide, cell, nucleic acid, amino acid, or other specified material or component that is present in a composition at a relative or absolute concentration that is higher than a starting composition.

The term “transformation” as used herein refers to the transfer or introduction of a nucleic acid molecule into a host organism. The nucleic acid molecule may be introduced as a linear or circular form of DNA. The nucleic acid molecule may be a plasmid that replicates autonomously, or it may integrate into the genome of a production host. Production hosts containing the transformed nucleic acid are referred to as “transformed” or “recombinant” or “transgenic” organisms or “transformants”.

The term “recombinant” as used herein refers to an artificial combination of two otherwise separated segments of nucleic acid sequences, e.g., by chemical synthesis or by the manipulation of isolated segments of nucleic acids by genetic engineering techniques. For example, DNA in which one or more segments or genes have been inserted, either naturally or by laboratory manipulation, from a different molecule, from another part of the same molecule, or an artificial sequence, resulting in the introduction of a new sequence in a gene and subsequently in an organism. The terms “recombinant”, “transgenic”, “transformed”, “engineered” or “modified for exogenous gene expression” are used interchangeably herein.

The term “microbial” herein is used interchangeably with “microorganism”. A viable microorganism is one which is metabolically active or able to differentiate.

The DFMs described herein comprise at least one viable microorganism such as a viable bacterial strain or a viable yeast or a viable fungi. Preferably, the DFM comprises at least one viable bacteria.

In one embodiment the DFM may be a spore forming bacterial strain and hence the term DFM may be comprised of or contain spores, e.g. bacterial spores. Thus, the term “viable microorganism” as used herein may include microbial spores, such as endospores or conidia. Alternatively, the DFM in the feed additive composition described herein may not comprise of or may not contain microbial spores, e.g. endospores or conidia.

The microorganism may be a naturally-occurring microorganism or it may be a transformed microorganism. Preferably, the microorganism is a combination of at least three suitable microorganisms, such as bacteria, that may be isolated.

A DFM as described herein may comprise microorganims from one or more of the following genera: Lactobacillus, Lactococcus, Streptococcus, Bacillus, Pediococcus, Enterococcus, Leuconostoc, Carnobacterium, Propionibacterium, Bifidobacterium, Clostridium and Megasphaera and combinations thereof.

Preferably, the DFM comprises one or more bacterial strains selected from the following Bacillus spp: Bacillus subtilis, Bacillus cereus, Bacillus licheniformis, Bacillus pumilis and Bacillus amyloliquefaciens.

The genus “Bacillus”, as used herein, includes all species within the genus “Bacillus,” as known to those of skill in the art, including but not limited to B. subtilis, B. licheniformis, B. lentus, B. brevis, B. stearothermophilus, B. alkalophilus, B. amyloliquefaciens, B. clausii, B. halodurans, B. megaterium, B. coagulans, B. circulans, B. gibsonii, B. pumilis and B. thuringiensis. It is recognized that the genus Bacillus continues to undergo taxonomical reorganization. Thus, it is intended that the genus include species that have been reclassified, including but not limited to such organisms as Bacillus stearothermophilus, which is now named “Geobacillus stearothermophilus”, or Bacillus polymyxa, which is now “Paenibacillus polymyxa” The production of resistant endospores under stressful environmental conditions is considered the defining feature of the genus Bacillus, although this characteristic also applies to the recently named Alicyclobacillus, Amphibacillus, Aneurinibacillus, Anoxybacillus, Brevibacillus, Filobacillus, Gracilibacillus, Halobacillus, Paenibacillus, Salibacillus, Thermobacillus, Ureibacillus, and Virgibacillus.

Preferably, the DFM may be a combination of three or more the Bacillus subtilis strains 3BP5 (NRRL B-50510); 918 (NRRL B-50508), and 1013 (NRRL B-50509). Strains 3BP5 (NRRL B-50510); 918 (NRRL B-50508), and 1013 (NRRL B-50509) are publically available from the Agricultural Research Service Culture Collection (NRRL). These strains are taught in WO2013029013.

In another aspect, the DFM may be further combined with the following Lactococcus spp: Lactococcus cremoris and Lactococcus lactis and combinations thereof.

The DFM may be further combined with the following Lactobacillus spp: Lactobacillus buchneri, Lactobacillus acidophilus, Lactobacillus casei, Lactobacillus kefiri, Lactobacillus bifidus, Lactobacillus brevis, Lactobacillus helveticus, Lactobacillus paracasei, Lactobacillus rhamnosus, Lactobacillus salivarius, Lactobacillus curvatus, Lactobacillus bulgaricus, Lactobacillus sakei, Lactobacillus reuteri, Lactobacillus fermentum, Lactobacillus farciminis, Lactobacillus lactis, Lactobacillus delbreuckii, Lactobacillus plantarum, Lactobacillus paraplantarum, Lactobacillus farciminis, Lactobacillus rhamnosus, Lactobacillus crispatus, Lactobacillus gasseri, Lactobacillus johnsonii and Lactobacillus jensenii, and combinations of any thereof.

In still another aspect, the DFM may be further combined with the following Bifidobacteria spp: Bifidobacterium lactis, Bifidobacterium bifidium, Bifidobacterium longum, Bifidobacterium animalis, Bifidobacterium breve, Bifidobacterium infantis, Bifidobacterium catenulatum, Bifidobacterium pseudocatenulatum, Bifidobacterium adolescentis, and Bifidobacterium angulatum, and combinations of any thereof.

There can be mentioned bacteria of the following species: Bacillus subtilis, Bacillus licheniformis, Bacillus amyloliquefaciens, Bacillus pumilis, Enterococcus, Enterococcus spp, and Pediococcus spp, Lactobacillus spp, Bifidobacterium spp, Lactobacillus acidophilus, Pediococsus acidilactici, Lactococcus lactis, Bifidobacterium bifidum, Bacillus subtilis, Propionibacterium thoenii, Lactobacillus farciminis, Lactobacillus rhamnosus, Megasphaera elsdenii, Clostridium butyricum, Bifidobacterium animalis ssp. animalis, Lactobacillus reuteri, Bacillus cereus, Lactobacillus salivarius ssp. Salivarius, Propionibacteria sp and combinations thereof.

The direct-fed microbial described herein comprising one or more bacterial strains may be of the same type (genus, species and strain) or may comprise a mixture of genera, species and/or strains.

Suitably the composition according to the present disclosure may be combined with one or more of the products or the microorganisms contained in those products disclosed in WO2012110778, and summarized as follows:

Bacillus subtilis strain 2084 Accession No. NRR1 B-50013, Bacillus subtilis strain LSSAO1 Accession No. NRRL B-50104, and Bacillus subtilis strain 15A-P4 ATCC Accession No. PTA-6507 (from Enviva Pro®. (formerly known as Avicorr®); Bacillus subtilis Strain C3102 (from Calsporin®); Bacillus subtilis Strain PB6 (from Clostat®); Bacillus pumilis (8G-134); Enterococcus NCIMB 10415 (SF68) (from Cylactin®); Bacillus subtilis Strain C3102 (from Gallipro® & GalliproMax®); Bacillus licheniformis (from Gallipro®Tect®); Enterococcus and Pediococcus (from Poultry Star®); Lactobacillus, Bifidobacterium and/or Enterococcus from Protexin®); Bacillus subtilis strain QST 713 (from Proflora®); Bacillus amyloliquefaciens CECT-5940 (from Ecobiol® & Ecobiol® Plus); Enterococcus faecium SF68 (from Fortiflora®); Bacillus subtilis and Bacillus licheniformis (from BioPlus2B®); Lactic acid bacteria 7 Enterococcus faecium (from Lactiferm®); Bacillus strain (from CSI®); Saccharomyces cerevisiae (from Yea-Sacc®); Enterococcus (from Biomin IMB52®); Pediococcus acidilactici, Enterococcus, Bifidobacterium animalis ssp. animalis, Lactobacillus reuteri, Lactobacillus salivarius ssp. salivarius (from Biomin C5®); Lactobacillus farciminis (from Biacton®); Enterococcus (from Oralin E1707®); Enterococcus (2 strains), Lactococcus lactis DSM 1103 (from Probios-pioneer PDFM®); Lactobacillus rhamnosus and Lactobacillus farciminis (from Sorbiflore®); Bacillus subtilis (from Animavit®); Enterococcus (from Bonvital®); Saccharomyces cerevisiae (from Levucell SB 20®); Saccharomyces cerevisiae (from Levucell SC 0 & SC10® ME); Pediococcus acidilacti (from Bactocell); Saccharomyces cerevisiae (from ActiSaf® (formerly BioSaf®)); Saccharomyces cerevisiae NCYC Sc47 (from Actisaf® SC47); Clostridium butyricum (from Miya-Gold®); Enterococcus (from Fecinor and Fecinor Plus®); Saccharomyces cerevisiae NCYC R-625 (from InteSwine®); Saccharomyces cerevisia (from BioSprint®); Enterococcus and Lactobacillus rhamnosus (from Provita®); Bacillus subtilis and Aspergillus oryzae (from PepSoyGen-C®); Bacillus cereus (from Toyocerin®); Bacillus cereus var. toyoi NCIMB 40112/CNCM I-1012 (from TOYOCERIN®), or other DFMs such as Bacillus licheniformis and Bacillus subtilis (from BioPlus® YC) and Bacillus subtilis (from GalliPro®).

The DFM may be combined with Enviva Pro® which is commercially available from Danisco A/S. Enviva Pro® is a combination of Bacillus strain 2084 Accession No. NRR1 B-50013, Bacillus strain LSSAO1 Accession No. NRRL B-50104 and Bacillus strain 15A-P4 ATCC Accession No. PTA-6507 (as taught in U.S. Pat. No. 7,754,469 B—incorporated herein by reference).

It is also possible to combine the DFM described herein with a yeast from the genera: Saccharomyces spp.

Preferably, the DFM described herein comprises microorganisms which are generally recognised as safe (GRAS) and, preferably are GRAS-approved.

A person of ordinary skill in the art will readily be aware of specific species and/or strains of microorganisms from within the genera described herein which are used in the food and/or agricultural industries and which are generally considered suitable for animal consumption.

Advantageously, where the product is a feed or feed additive composition, the DFM should remain effective through the normal “sell-by” or “expiration” date of the product during which the feed or feed additive composition is offered for sale by the retailer. The desired lengths of time and normal shelf life will vary from feedstuff to feedstuff and those of ordinary skill in the art will recognise that shelf-life times will vary upon the type of feedstuff, the size of the feedstuff, storage temperatures, processing conditions, packaging material and packaging equipment.

In some embodiments, it is important that the DFM be heat tolerant, i.e. is thermotolerant. This is particularly the case when the feed is pelleted. Therefore, in another embodiment, the DFM may be a thermotolerant microorganism, such as a thermotolerant bacteria, including for example Bacillus spp.

In other aspects, it may be desirable that the DFM comprises a spore producing bacteria, such as Bacilli, e.g. Bacillus spp. Bacilli are able to form stable endospores when conditions for growth are unfavorable and are very resistant to heat, pH, moisture and disinfectants.

The DFM described herein may decrease or prevent intestinal establishment of pathogenic microorganism (such as Clostridium perfringens and/or E. coli and/or Salmonella spp and/or Campylobacter spp.). In other words, the DFM may be antipathogenic. The term “antipathogenic” as used herein means the DFM counters an effect (negative effect) of a pathogen.

As described above, the DFM may be any suitable DFM. For example, the following assay “DFM ASSAY” may be used to determine the suitability of a microorganism to be a DFM. The DFM assay as used herein is explained in more detail in US2009/0280090. For avoidance of doubt, the DFM selected as an inhibitory strain (or an antipathogenic DFM) in accordance with the “DFM ASSAY” taught herein is a suitable DFM for use in accordance with the present disclosure, i.e. in the feed additive composition according to the present disclosure.

Tubes were seeded each with a representative pathogen (e.g., bacteria) from a representative cluster.

Supernatant from a potential DFM, grown aerobically or anaerobically, is added to the seeded tubes (except for the control to which no supernatant is added) and incubated. After incubation, the optical density (OD) of the control and supernatant treated tubes was measured for each pathogen.

Colonies of (potential DFM) strains that produced a lowered OD compared with the control (which did not contain any supernatant) can then be classified as an inhibitory strain (or an antipathogenic DFM). Thus, The DFM assay as used herein is explained in more detail in US2009/0280090.

Preferably, a representative pathogen used in this DFM assay can be one (or more) of the following: Clostridium, such as Clostridium perfringens and/or Clostridium difficile, and/or E. coli and/or Salmonella spp and/or Campylobacter spp. In one preferred embodiment the assay is conducted with one or more of Clostridium perfringens and/or Clostridium difficile and/or E. coli, preferably Clostridium perfringens and/or Clostridium difficile, more preferably Clostridium perfringens.

Antipathogenic DFMs include one or more of the following bacteria and are described in WO2013029013:

Bacillus subtilis strain 3BP5 Accession No. NRRL B-50510,
Bacillus subtilis strain 918 ATCC Accession No. NRRL B-50508, and
Bacillus subtilis strain 1013 ATCC Accession No. NRRL B-50509.

DFMs may be prepared as culture(s) and carrier(s) (where used) and can be added to a ribbon or paddle mixer and mixed for about 15 minutes, although the timing can be increased or decreased. The components are blended such that a uniform mixture of the cultures and carriers result. The final product is preferably a dry, flowable powder. The DFM(s) comprising one or more bacterial strains can then be added to animal feed or a feed premix, added to an animal's water, or administered in other ways known in the art (preferably simultaneously with the enzymes described herein.

Inclusion of the individual strains in the DFM mixture can be in proportions varying from 1% to 99% and, preferably, from 25% to 75%.

Suitable dosages of the DFM in animal feed may range from about 1×10³ CFU/g feed to about 1×10¹⁰ CFU/g feed, suitably between about 1×10⁴ CFU/g feed to about 1×10⁸ CFU/g feed, suitably between about 7.5×10⁴ CFU/g feed to about 1×10⁷ CFU/g feed.

In another aspect, the DFM may be dosed in feedstuff at more than about 1×10³ CFU/g feed, suitably more than about 1×10⁴ CFU/g feed, suitably more than about 5×10⁴ CFU/g feed, or suitably more than about 1×10⁵ CFU/g feed.

The DFM may be dosed in a feed additive composition from about 1×10³ CFU/g composition to about 1×10¹³ CFU/g composition, preferably 1×10⁵ CFU/g composition to about 1×10¹³ CFU/g composition, more preferably between about 1×10⁶ CFU/g composition to about 1×10¹² CFU/g composition, and most preferably between about 3.75×10⁷ CFU/g composition to about 1×10¹¹ CFU/g composition. In another aspect, the DFM may be dosed in a feed additive composition at more than about 1×10⁵ CFU/g composition, preferably more than about 1×10⁶ CFU/g composition, and most preferably more than about 3.75×10⁷ CFU/g composition. In one embodiment the DFM is dosed in the feed additive composition at more than about 2×10⁵ CFU/g composition, suitably more than about 2×10⁶ CFU/g composition, suitably more than about 3.75×10⁷ CFU/g composition.

A feed additive composition as described herein consists essentially of a DFM comprising one or more bacterial strains and at least one protease. The protease may be a subtilisin (E.C. 3.4.21.62) or a bacillolysin (E.C. 3.4.24.28) or an alkaline serine protease (E.C. 3.4.21.x) or a keratinase (E.C. 3.4.x.x). The preferred protease is a subtilisin. The protease may be from B. subtilis or the protease may be a Nocardiopsis protease available from Novozymes A/S.

Other suitable proteases include those of animal, vegetable or microbial origin. Chemically modified or protein engineered mutant proteases can also be used. The protease may be a serine protease or a metalloprotease, e.g., an alkaline microbial protease or a trypsin-like protease. Examples of alkaline proteases are subtilisins, especially those derived from Bacillus sp., e.g., subtilisin Novo, subtilisin Carlsberg, subtilisin 309 (see, e.g., U.S. Pat. No. 6,287,841), subtilisin 147, and subtilisin 168 (see, e.g., WO 89/06279). Examples of trypsin-like proteases are trypsin (e.g., of porcine or bovine origin), and Fusarium proteases (see, e.g., WO 89/06270 and WO 94/25583). Examples of useful proteases also include but are not limited to the variants described in WO 92/19729 and WO 98/20115.

One or more of the proteases in one or more of the commercial products below can be used in combination with the three-strain direct fed microbial described herein:

| Commercial | | | |
|---|---|---|---|
| product ® | Company | Protease type | Protease source |
| Avizyme 1100 | Danisco A/S | Subtilisin | Bacillus subtilis |
| Avizyme 1202 | Danisco A/S | Subtilisin | Bacillus subtilis |
| Avizyme 1302 | Danisco A/S | Subtilisin | Bacillus subtilis |
| Avizyme 1500 | Danisco A/S | Subtilisin | Bacillus subtilis |
| Avizyme 1505 | Danisco A/S | Subtilisin | Bacillus subtilis |
| Multifect P3000 | | | |
| Kemzyme | Kemin | Bacillolysin | Bacillus |
| Plus Dry | | | amyloliquefaciens |
| Kemzyme | Kemin | Bacillolysin | Bacillus |
| W dry | | | amyloliquefaciens |
| Natuzyme | Bioproton | Protease | Trichoderma |
| | | | longibrachiatum/ |
| | | | Trichoderma |
| | | | reesei |
| Porzyme 8300 | Danisco | Subtilisin | Bacillus subtilis |
| Ronozyme | DSM/ | Alkaline serine | Nocardiopsis |
| ProAct | Novozymes | protease | prasina gene |
| | | | expressed in |
| | | | Bacillus |
| | | | licheniformis |
| Versazyme/ | Novus | Keratinase | Bacillus |
| Cibenza | | | licheniformis |
| DP100 | | | |

Preferably, the protease is present in the feedstuff in range of about 1000 PU/kg to about 200,000 PU/kg feed, more preferably about 1500 PU/kg feed to about 100000 PU/kg feed, more preferably about 2000 PU/kg feed to about 60000 PU/kg feed. More specidically, the protease is present in the feedstuff at more than about 1000 PU/kg feed or more than about 1500 PU/kg feed, or more than about 2000 PU/kg feed. In another aspect, the protease is present in the feedstuff at less than about 200,000 PU/kg feed or less than about 100000 PU/kg feed or less than about 70000 PU/kg feed or less than about 60000 PU/kg feed.

The protease may be present in the feed additive composition in range of about 200 PU/g to about 400,000 PU/g composition, more preferably about 300 PU/g composition to about 200,000 PU/g composition, and even more preferably about 5000 PU/g composition to about 100,000 PU/g composition, and even more preferably about 700 PU/g composition to about 70,000 PU/g composition, and even more preferably about 1000 PU/g composition to about 60,000 PU/g composition.

In another aspect, the protease is present in the feed additive composition at more than about 200 PU/g composition or more than about 300 PU/g composition or more than about 400 PU/g composition or than about 500 PU/g composition or more than about 750 PU/g composition or more than about 1000 PU/g composition.

In still another aspect, the protease is present in the feed additive composition at less than about 400,000 PU/g composition or less than about 200,000 PU/g composition or less than about 100,000 PU/g composition or less than about 80,000 PU/g composition or less than about 70000 PU/g composition or less than about 60000 PU/g composition.

It will be understood that one protease unit (PU) is the amount of enzyme that liberates 2.3 micrograms of phenolic compound (expressed as tyrosine equivalents) from a casein substrate per minute at pH 10.0 at 50° C. This may be referred to as the assay for determining 1 PU.

Without wishing to be bound in theory, proteases cause non-specific hydrolysis of dietary protein yielding a variety of polypeptides in the intestinal lumen. Animals finalize protein hydrolysis and absorb such amino acids. However, in the case of enteric pathogenic challenges, pathogenic bacteria may take advantage of higher peptide availability in the lumen of jejunum and ileum. DFM(s) inhibit the growth of entero-pathogens by for example competing for N sources, as well as by direct inhibition.

The specific combination of DFM comprising one or more baceterium and the at least one protease taught herein may advantageously lead to reduced mucin secretion. It is believed that this reduced mucin secretion may result in a reduction of endogenous amino acid losses, and/or may be responsible for improved performance.

The specific combination of DFM comprising one or more baceterium and the at least one protease taught herein may advantageously reduce inflammation in the ileum. This can be seen by the downregulation of Interferon gamma (IFN gamma) expression in the ileum.

The feed additive composition described herein can be fed to an animal as a direct-fed microbial (DFM). One or more carrier(s) or other ingredients can be added to the DFM. The DFM may be presented in various physical forms, for example, as a top dress, as a water soluble concentrate for use as a liquid drench or to be added to a milk replacer, gelatin capsule, or gels. In one embodiment of the top dress form, freeze-dried fermentation product is added to a carrier, such as whey, maltodextrin, sucrose, dextrose, limestone (calcium carbonate), rice hulls, yeast culture, dried starch, and/or sodium silico aluminate. In one embodiment of the water soluble concentrate for a liquid drench or milk replacer supplement, freeze-dried fermentation product is added to a water soluble carrier, such as whey, maltodextrin, sucrose, dextrose, dried starch, sodium silico aluminate, and a liquid is added to form the drench or the supplement is added to milk or a milk replacer. In one embodiment of the gelatin capsule form, freeze-dried fermentation product is added to a carrier, such as whey, maltodextrin, sugar, limestone (calcium carbonate), rice hulls, yeast culture dried starch, and/or sodium silico aluminate. In one embodiment, the bacteria and carrier are enclosed in a degradable gelatin capsule. In one embodiment of the gels form, freeze-dried fermentation product is added to a carrier, such as vegetable oil, sucrose, silicon dioxide, polysorbate 80, propylene glycol, butylated hydroxyanisole, citric acid, ethoxyquin, and/or artificial coloring to form the gel.

The DFM(s) may optionally be admixed with a dry formulation of additives including but not limited to growth substrates, enzymes, sugars, carbohydrates, extracts and growth promoting micro-ingredients. The sugars could include the following: lactose; maltose; dextrose; malto-dextrin; glucose; fructose; mannose; tagatose; sorbose; raffinose; and galactose. The sugars range from 50-95%, either individually or in combination. The extracts could include yeast or dried yeast fermentation solubles ranging from 5-50%. The growth substrates could include: trypticase, ranging from 5-25%; sodium lactate, ranging from 5-30%; and, Tween 80, ranging from 1-5%. The carbohydrates could include mannitol, sorbitol, adonitol and arabitol. The carbohydrates range from 5-50% individually or in combination. The micro-ingredients could include the following: calcium carbonate, ranging from 0.5-5.0%; calcium chloride, ranging from 0.5-5.0%; dipotassium phosphate, ranging from 0.5-5.0%; calcium phosphate, ranging from 0.5-5.0%; manganese proteinate, ranging from 0.25-1.00%; and, manganese, ranging from 0.25-1.0%.

The DFM comprising one or more bacterial strains and the at least one protease may be formulated in any suitable way to ensure that the formulation comprises viable DFMs and at least one active protease. In one embodiment the DFM comprising one or more bacterial strains and at least one protease may be formulated as a liquid, a dry powder or a granule.

The dry powder or granules may be prepared by means known to those skilled in the art, such as, in top-spray fluid bed coater, in a buttom spray Wurster or by drum granulation (e.g. High sheer granulation), extrusion, pan coating or in a microingredients mixer.

For some embodiments the DFM and/or the at least one protease may be coated, for example encapsulated. Suitably the DFM and the at least one protease may be formulated within the same coating or encapsulated within the same capsule. Alternatively one or two or three or four of the enzymes may be formulated within the same coating or encapsulated within the same capsule and the DFM could be formulated in a coating separate to the one or more or all of the enzymes.

In some embodiments, such as where the DFM is capable of producing endospores, the DFM may be provided without any coating. In such circumstances, the DFM endospores may be simply admixed with at least one protease. In the latter case, the at least one protease may be coated, e.g. encapsulated.

In one embodiment, the coating protects enzymes such as the at lease one protease from heat and may be considered a thermoprotectant.

In another aspect, the feed additive composition is formulated to a dry powder or granules as described in WO2007/044968 (referred to as TPT granules) or WO1997/016076 or WO1992/012645 (each of which is incorporated herein by reference).

The feed additive composition may be formulated to a granule which is then added to the teed, the granule comprises a core; an active agent; and at least one coating, the active agent of the granule retaining at least 50% activity, at least 60% activity, at least 70% activity, at least 80% activity after conditions selected from one or more of a) a feed pelleting process, b) a steam-heated feed pretreatment process, c) storage, d) storage as an ingredient in an unpelleted mixture, and e) storage as an ingredient in a feed base mix or a teed premix comprising at least one compound selected from trace minerals, organic acids, reducing sugars, vitamins, choline chloride, and compounds which result in an acidic or a basic teed base mix or feed premix.

With regard to the granule at least one coating may comprise a moisture hydrating material that constitutes at least 55% w/w of the granule; and/or at least one coating may comprise two coatings. The two coatings may be a moisture hydrating coating and a moisture barrier coating. In some embodiments, the moisture hydrating coating may be between 25% and 60% w/w of the granule and the moisture barrier coating may be between 2% and 15% w/w of the granule. The moisture hydrating coating may be selected from inorganic salts, sucrose, starch, and maltodextrin and the moisture barrier coating may be selected from polymers, gums, whey and starch. Feed containing the feed additive composition may be produced using a feed pelleting process and the feed pretreatment process may be conducted between 70° C. and 95° C. for at least 30 seconds up to several minutes at a temperature between 85° C. and 95° C.

Feed containing the feed additive composition may be produced using a steam-heated pelleting process which may be conducted between 85° C. and 95° C. for anywhere from about 30 seconds up to several minutes.

In some embodiments the DFM (e.g. DFM endospores for example) may be diluted using a diluent, such as starch powder, lime stone or the like.

In one embodiment, the composition is in a liquid formulation suitable for consumption preferably such liquid consumption contains one or more of the following: a buffer, salt, sorbitol and/or glycerol.

In another embodiment the feed additive composition may be formulated by applying, e.g. spraying, the enzyme(s) onto a carrier substrate, such as ground wheat for example.

In one embodiment, the feed additive composition may be formulated as a premix. By way of example only the premix may comprise one or more feed components, such as one or more minerals and/or one or more vitamins.

In another embodiment, the DFM comprising one or more bacterial strains and/or the at least one protease can be formulated with at least one physiologically acceptable carrier selected from at least one of maltodextrin, limestone (calcium carbonate), cyclodextrin, wheat or a wheat component, sucrose, starch, Na₂SO₄, Talc, PVA, sorbitol, benzoate, sorbiate, glycerol, sucrose, propylene glycol, 1,3-propane diol, glucose, parabens, sodium chloride, citrate, acetate, phosphate, calcium, metabisulfite, formate and mixtures thereof.

In one embodiment the feed additive composition and/or premix and/or feed or feedstuff is packaged.

In one preferred embodiment the feed additive composition and/or premix and/or feed or feedstuff is packaged in a bag, such as a paper bag.

In an alternative embodiment the feed additive composition and/or premix and/or feed or feedstuff may be sealed in a container. Any suitable container may be used.

The feed additive composition as described herein may be used as—or in the preparation of—a feed.

The term “feed” is used interchangeably with the term “feedstuff”. As used herein, the term “feedstuff” refers to a feed material to which one or more feed additive compositions have been added.

The feed may be in the form of a solution or as a solid—depending on the use and/or the mode of application and/or the mode of administration.

When used as feed, or in the preparation of a feed, such as functional feed, the feed additive composition described herein may be used in conjunction with one or more of: a nutritionally acceptable carrier, a nutritionally acceptable diluent, a nutritionally acceptable excipient, a nutritionally acceptable adjuvant, a nutritionally active ingredient.

In a preferred embodiment the feed additive composition can be admixed with a feed component to form a feedstuff.

The term “feed component” as used herein means all or part of the feedstuff. Part of the feedstuff may mean one constituent of the feedstuff or more than one constituent of the feedstuff, e.g. 2 or 3 or 4. In one embodiment the term “feed component” encompasses a premix or premix constituents.

Preferably the feed may be a fodder, or a premix thereof, a compound feed, or a premix thereof. In one embodiment the feed additive composition may be admixed with a compound feed, a compound feed component or to a premix of a compound feed or to a fodder, a fodder component, or a premix of a fodder.

The term fodder as used herein means any food which is provided to an animal (rather than the animal having to forage for it themselves). Fodder encompasses plants that have been cut.

The term fodder includes hay, straw, silage, compressed and pelleted feeds, oils and mixed rations, and also sprouted grains and legumes.

Fodder may be obtained from one or more of the plants selected from: alfalfa (lucerne), barley, birdsfoot trefoil, brassicas, Chau moellier, kale, rapeseed (canola), rutabaga (swede), turnip, clover, alsike clover, red clover, subterranean clover, white clover, grass, false oat grass, fescue, Bermuda grass, brome, heath grass, meadow grasses (from naturally mixed grassland swards, orchard grass, rye grass, Timothy-grass, corn (maize), millet, oats, sorghum, soybeans, trees (pollard tree shoots for tree-hay), wheat, and legumes.

The term “compound feed” means a commercial feed in the form of a meal, a pellet, nuts, cake or a crumble. Compound feeds may be blended from various raw materials and additives. These blends are formulated according to the specific requirements of the target animal.

Compound feeds can be complete feeds that provide all the daily required nutrients, concentrates that provide a part of the ration (protein, energy) or supplements that only provide additional micronutrients, such as minerals and vitamins.

The main ingredients used in compound feed are the feed grains, which include corn, soybeans, sorghum, oats, and barley.

Suitably a premix as referred to herein may be a composition composed of microingredients such as vitamins, minerals, chemical preservatives, antibiotics, fermentation products, and other essential ingredients. Premixes are usually compositions suitable for blending into commercial rations.

Any feedstuff described herein may comprise one or more feed materials selected from the group comprising a) cereals, such as small grains (e.g., wheat, barley, rye, oats and combinations thereof) and/or large grains such as maize or sorghum; b) by products from cereals, such as corn gluten meal, Distillers Dried Grain Solubles (DDGS), wheat bran, wheat middlings, wheat shorts, rice bran, rice hulls, oat hulls, palm kernel, and citrus pulp; c) protein obtained from sources such as soya, sunflower, peanut, lupin, peas, fava beans, cotton, canola, fish meal, dried plasma protein, meat and bone meal, potato protein, whey, copra, sesame; d) oils and fats obtained from vegetable and animal sources; e) minerals and vitamins.

Furthermore, such feedstuff may contain at least 30%, at least 40%, at least 50% or at least 60% by weight corn and soybean meal or corn and full fat soy, or wheat meal or sunflower meal. In addition or in the alternative, a feedstuff may comprise at least one high fibre feed material and/or at least one by-product of the at least one high fibre feed material to provide a high fibre feedstuff. Examples of high fibre feed materials include: wheat, barley, rye, oats, by products from cereals, such as corn gluten meal, Distillers Dried Grain Solubles (DDGS), wheat bran, wheat middlings, wheat shorts, rice bran, rice hulls, oat hulls, palm kernel, and citrus pulp. Some protein sources may also be regarded as high fibre: protein obtained from sources such as sunflower, lupin, fava beans and cotton.

As described herein, feed may be one or more of the following: a compound feed and premix, including pellets, nuts or (cattle) cake; a crop or crop residue: corn, soybeans, sorghum, oats, barley, corn stover, copra, straw, chaff, sugar beet waste; fish meal; freshly cut grass and other forage plants; meat and bone meal; molasses; oil cake and press cake; oligosaccharides; conserved forage plants: hay and silage; seaweed; seeds and grains, either whole or prepared by crushing, milling etc.; sprouted grains and legumes; yeast extract.

The term feed as used herein also encompasses in some embodiments pet food. A pet food is plant or animal material intended for consumption by pets, such as dog food or cat food. Pet food, such as dog and cat food, may be either in a dry form, such as kibble for dogs, or wet canned form. Cat food may contain the amino acid taurine.

The term feed may also encompass in some embodiments fish food. A fish food normally contains macro nutrients, trace elements and vitamins necessary to keep captive fish in good health. Fish food may be in the form of a flake, pellet or tablet. Pelleted forms, some of which sink rapidly, are often used for larger fish or bottom feeding species. Some fish foods also contain additives, such as beta carotene or sex hormones, to artificially enhance the color of ornamental fish.

Also encompassed within the term “feed” is bird food including food that is used both in birdfeeders and to feed pet birds. Typically bird food comprises of a variety of seeds, but may also encompass suet (beef or mutton fat).

As used herein the term “contacted” refers to the indirect or direct application of the feed additive composition to the product (e.g. the feed). Examples of the application methods which may be used, include, but are not limited to, treating the product in a material comprising the feed additive composition, direct application by mixing the feed additive composition with the product, spraying the feed additive composition onto the product surface or dipping the product into a preparation of the feed additive composition.

This feed additive composition is preferably admixed with the product (e.g. feedstuff). Alternatively, the feed additive composition may be included in the emulsion or raw ingredients of a feedstuff.

For some applications, it is important that the composition is made available on or to the surface of a product to be affected/treated. This allows the composition to impart one or more of the following favourable characteristics: performance benefits.

The feed additive compositions may be applied to intersperse, coat and/or impregnate a product (e.g. feedstuff or raw ingredients of a feedstuff) with a controlled amount of DFM and enzymes.

The DFM comprising at least one bacterial strain and at least one protease may be used simultaneously (e.g. when they are in admixture together or even when they are delivered by different routes) or sequentially (e.g. they may be delivered by different routes). In one embodiment preferably the DFM and enzymes are applied simultaneously. Preferably the DFM comprising at least one bacterial strain and at least one protease are admixed prior to being delivered to a feedstuff or to a raw ingredient of a feedstuff.

The DFM comprising at least one bacterial strain and at least one protease can be added in suitable concentrations, for example, in concentrations in the final feed product which offer a daily dose of between about 2×10³ CFU/g of feed to about 2×10¹¹ CFU/g of feed, suitably between about 2×10⁶ to about 1×10¹⁰, suitably between about 3.75×10⁷ CFU/g of feed to about 1×10¹⁰ CFU/g of feed.

Preferably, the feed additive composition will be thermally stable to heat treatment up to about 70° C.; up to about 85° C.; or up to about 95° C. The heat treatment may be performed from about 30 seconds up to several minutes. The term thermally stable means that at least about 50% of the enzyme components and/or DFM that were present/active in the additive before heating to the specified temperature are still present/active after it cools to room temperature. In a particularly preferred embodiment the feed additive composition is homogenized to produce a powder.

Alternatively, the feed additive composition is formulated to granules as described in WO2007/044968 (referred to as TPT granules) incorporated herein by reference.

In another preferred embodiment when the feed additive composition is formulated into granules the granules comprise a hydrated barrier salt coated over the protein core. The advantage of such salt coating is improved thermo-tolerance, improved storage stability and protection against other feed additives otherwise having adverse effect on the at least one protease and/or DFM comprising one or more bacterial strains. Preferably, the salt used for the salt coating has a water activity greater than 0.25 or constant humidity greater than 60% at 20° C. Preferably, the salt coating comprises a Na₂SO₄.

Feed containing the feed additive composition may be produced using a feed pelleting process. Optionally, the pelleting step may include a steam treatment, or conditioning stage, prior to formation of the pellets. The mixture comprising the powder may be placed in a conditioner, e.g. a mixer with steam injection. The mixture is heated in the conditioner up to a specified temperature, such as from 60-100° C., typical temperatures would be 70° C., 80° C., 85° C., 90° C. or 95° C. The residence time can be variable from seconds to minutes and even hours. Such as 5 seconds, 10 seconds, 15 seconds, 30 seconds, 1 minutes 2 minutes, 5 minutes, 10 minutes, 15 minutes, 30 minutes and 1 hour.

It will be understood that the feed additive composition as disclosed herein is suitable for addition to any appropriate feed material.

As used herein, the term feed material refers to the basic feed material to be consumed by an animal. It will be further understood that this may comprise, for example, at least one or more unprocessed grains, and/or processed plant and/or animal material such as soybean meal or bone meal.

It will be understood by the skilled person that different animals require different feedstuffs, and even the same animal may require different feedstuffs, depending upon the purpose for which the animal is reared.

Preferably, the feedstuff may comprise feed materials comprising maize or corn, wheat, barley, triticale, rye, rice, tapioca, sorghum, and/or any of the by-products, as well as protein rich components like soybean mean, rape seed meal, canola meal, cotton seed meal, sunflower seed mean, animal-by-product meals and mixtures thereof. More preferably, the feedstuff may comprise animal fats and/or vegetable oils.

Optionally, the feedstuff may also contain additional minerals such as, for example, calcium and/or additional vitamins. Preferably, the feedstuff is a corn soybean meal mix.

In another aspect there is provided a method for producing a feedstuff. Feedstuff is typically produced in feed mills in which raw materials are first ground to a suitable particle size and then mixed with appropriate additives. The feedstuff may then be produced as a mash or pellets; the later typically involves a method by which the temperature is raised to a target level and then the feed is passed through a die to produce pellets of a particular size. The pellets are allowed to cool. Subsequently liquid additives such as fat and enzyme may be added. Production of feedstuff may also involve an additional step that includes extrusion or expansion prior to pelleting, in particular, by suitable techniques that may include at least the use of steam.

The feedstuff may be a feedstuff for a monogastric animal, such as poultry (for example, broiler, layer, broiler breeders, turkey, duck, geese, water fowl), swine (all age categories), a pet (for example dogs, cats) or fish, preferably the feedstuff is for poultry. In one embodiment the feedstuff is not for a layer.

By way of example only a feedstuff for chickens, e.g. broiler chickens may be comprises of one or more of the ingredients listed in the table below, for example in the % ages given in the table below:

| Ingredients | Starter (%) | Finisher (%) |
|---|---|---|
| Maize | 46.2 | 46.7 |
| Wheat Middlings | 6.7 | 10.0 |
| Maize DDGS | 7.0 | 7.0 |
| Soyabean Meal 48% CP | 32.8 | 26.2 |
| An/Veg Fat blend | 3.0 | 5.8 |
| L-Lysine HCl | 0.3 | 0.3 |
| DL-methionine | 0.3 | 0.3 |
| L-threonine | 0.1 | 0.1 |
| Salt | 0.3 | 0.4 |
| Limestone | 1.1 | 1.1 |
| Dicalcium Phosphate | 1.2 | 1.2 |
| Poultry Vitamins and | 0.3 | 0.3 |
| Micro-minerals | | |

By way of example only the diet specification for chickens, such as broiler chickens, may be as set out in the Table below:

| Diet specification | | |
|---|---|---|
| Crude Protein (%) | 23.00 | 20.40 |
| Metabolizable Energy Poultry | 2950 | 3100 |
| (kcal/kg) | | |
| Calcium (%) | 0.85 | 0.85 |
| Available Phosphorus (%) | 0.38 | 0.38 |
| Sodium (%) | 0.18 | 0.19 |
| Dig. Lysine (%) | 1.21 | 1.07 |
| Dig. Methionine (%) | 0.62 | 0.57 |
| Dig. Methionine + Cysteine (%) | 0.86 | 0.78 |
| Dig. Threonine (%) | 0.76 | 0.68 |

By way of example only a feedstuff laying hens may be comprises of one or more of the ingredients listed in the table below, for example in the % ages given in the table below:

| Ingredient | Laying phase (%) |
|---|---|
| Maize | 10.0 |
| Wheat | 53.6 |
| Maize DDGS | 5.0 |
| Soybean Meal 48% CP | 14.9 |
| Wheat Middlings | 3.0 |
| Soybean Oil | 1.8 |
| L-Lysine HCl | 0.2 |
| DL-methionine | 0.2 |
| L-threonine | 0.1 |
| Salt | 0.3 |
| Dicalcium Phosphate | 1.6 |
| Limestone | 8.9 |
| Poultry Vitamins and Micro- | 0.6 |
| minerals | |

By way of example only the diet specification for laying hens may be as set out in the Table below:

| Diet specification | |
|---|---|
| Crude Protein (%) | 16.10 |
| Metabolizable Energy Poultry | 2700 |
| (kcal/kg) | |
| Lysine (%) | 0.85 |
| Methionine (%) | 0.42 |
| Methionine + Cysteine (%) | 0.71 |
| Threonine (%) | 0.60 |
| Calcium (%) | 3.85 |
| Available Phosphorus (%) | 0.42 |
| Sodium (%) | 0.16 |

By way of example only a feedstuff for turkeys may be comprises of one or more of the ingredients listed in the table below, for example in the % ages given in the table below:

| | Phase 1 | Phase 2 | Phase 3 | Phase 4 |
|---|---|---|---|---|
| Ingredient | (%) | (%) | (%) | (%) |
| Wheat | 33.6 | 42.3 | 52.4 | 61.6 |
| Maize DDGS | 7.0 | 7.0 | 7.0 | 7.0 |
| Soyabean Meal | 44.6 | 36.6 | 27.2 | 19.2 |
| 48% CP | | | | |
| Rapeseed Meal | 4.0 | 4.0 | 4.0 | 4.0 |
| Soyabean Oil | 4.4 | 4.2 | 3.9 | 3.6 |
| L-Lysine HCl | 0.5 | 0.5 | 0.4 | 0.4 |
| DL-methionine | 0.4 | 0.4 | 0.3 | 0.2 |
| L-threonine | 0.2 | 0.2 | 0.1 | 0.1 |
| Salt | 0.3 | 0.3 | 0.3 | 0.3 |
| Limestone | 1.0 | 1.1 | 1.1 | 1.0 |
| Dicalcium Phosphate | 3.5 | 3.0 | 2.7 | 2.0 |
| Poultry Vitamins and | 0.4 | 0.4 | 0.4 | 0.4 |
| Micro-minerals | | | | |

By way of example only the diet specification for turkeys may be as set out in the Table below:

| Diet specification | | | | |
|---|---|---|---|---|
| Crude Protein (%) | 29.35 | 26.37 | 22.93 | 20.00 |
| Metabolizable Energy Poultry | 2.850 | 2.900 | 2.950 | 3.001 |
| (kcal/kg) | | | | |
| Calcium (%) | 1.43 | 1.33 | 1.22 | 1.02 |
| Available Phosphorus (%) | 0.80 | 0.71 | 0.65 | 0.53 |
| Sodium (%) | 0.16 | 0.17 | 0.17 | 0.17 |
| Dig. Lysine (%) | 1.77 | 1.53 | 1.27 | 1.04 |
| Dig. Methionine (%) | 0.79 | 0.71 | 0.62 | 0.48 |
| Dig. Methionine + Cysteine (%) | 1.12 | 1.02 | 0.90 | 0.74 |
| Dig. Threonine (%) | 1.03 | 0.89 | 0.73 | 0.59 |

By way of example only a feedstuff for piglets may be comprises of one or more of the ingredients listed in the table below, for example in the % ages given in the table below:

| Ingredient | Phase 1 (%) | Phase 2 (%) |
|---|---|---|
| Maize | 20.0 | 7.0 |
| Wheat | 25.9 | 46.6 |
| Rye | 4.0 | 10.0 |
| Wheat middlings | 4.0 | 4.0 |
| Maize DDGS | 6.0 | 8.0 |
| Soyabean Meal 48% CP | 25.7 | 19.9 |
| Dried Whey | 10.0 | 0.0 |
| Soyabean Oil | 1.0 | 0.7 |
| L-Lysine HCl | 0.4 | 0.5 |
| DL-methionine | 0.2 | 0.2 |
| L-threonine | 0.1 | 0.2 |
| L-tryptophan | 0.03 | 0.04 |
| Limestone | 0.6 | 0.7 |
| Dicalcium Phosphate | 1.6 | 1.6 |
| Swine Vitamins and | 0.2 | 0.2 |
| Micro-minerals | | |
| Salt | 0.2 | 0.4 |

By way of example only the diet specification for piglets may be as set out in the Table below:

| Diet specification | | |
|---|---|---|
| Crude Protein (%) | 21.50 | 20.00 |
| Swine Digestible Energy | 3380 | 3320 |
| (kcal/kg) | | |
| Swine Net Energy (kcal/kg) | 2270 | 2230 |
| Calcium (%) | 0.80 | 0.75 |
| Digestible Phosphorus (%) | 0.40 | 0.35 |
| Sodium (%) | 0.20 | 0.20 |
| Dig. Lysine (%) | 1.23 | 1.14 |
| Dig. Methionine (%) | 0.49 | 0.44 |
| Dig. Methionine + Cysteine (%) | 0.74 | 0.68 |
| Dig. Threonine (%) | 0.80 | 0.74 |

By way of example only a feedstuff for grower/finisher pigs may be comprises of one or more of the ingredients listed in the table below, for example in the % ages given in the table below:

| Ingredient | Grower/Finisher (%) |
|---|---|
| Maize | 27.5 |
| Soyabean Meal 48% CP | 15.4 |
| Maize DDGS | 20.0 |
| Wheat bran | 11.1 |
| Rice bran | 12.0 |
| Canola seed meal | 10.0 |
| Limestone | 1.6 |
| Dicalcium phosphate | 0.01 |
| Salt | 0.4 |
| Swine Vitamins and Micro-minerals | 0.3 |
| Lysine-HCl | 0.2 |
| Vegetable oil | 0.5 |

By way of example only the diet specification for grower/finisher pigs may be as set out in the Table below:

| Diet specification | |
|---|---|
| Crude Protein (%) | 22.60 |
| Swine Metabolizable Energy | 3030 |
| (kcal/kg) | |
| Calcium (%) | 0.75 |
| Available Phosphorus (%) | 0.29 |
| Digestible Lysine (%) | 1.01 |
| Dig. Methionine + Cysteine (%) | 0.73 |
| Digestible Threonine (%) | 0.66 |

The feed additive composition described herein and other components and/or the feedstuff comprising same may be used in any suitable form, such as, solid or liquid preparations or alternatives thereof. Examples of solid preparations include powders, pastes, boluses, capsules, pellets, tablets, dusts, and granules which may be wettable, spray-dried or freeze-dried. Examples of liquid preparations include, but are not limited to, aqueous, organic or aqueous-organic solutions, suspensions and emulsions.

In some applications, feed additive compositions may be mixed with feed or administered in the drinking water. In one embodiment the dosage range for inclusion into water is about 1×10³ CFU/animal/day to about 1×10¹⁰ CFU/animal/day, and more preferably about 1×10⁷ CFU/animal/day.

Suitable examples of forms include one or more of: powders, pastes, boluses, pellets, tablets, pills, capsules, ovules, solutions or suspensions, which may contain flavouring or colouring agents, for immediate-, delayed-, modified-, sustained-, pulsed- or controlled-release applications.

By way of example, if the feed additive composition described herein is used in a solid form, it may also contain one or more of: excipients such as microcrystalline cellulose, lactose, sodium citrate, calcium carbonate, dibasic calcium phosphate and glycine; disintegrants such as starch (preferably corn, potato or tapioca starch), sodium starch glycollate, croscarmellose sodium and certain complex silicates; granulation binders such as polyvinylpyrrolidone, hydroxypropylmethylcellulose (HPMC), hydroxypropylcellulose (HPC), sucrose, gelatin and acacia; lubricating agents such as magnesium stearate, stearic acid, glyceryl behenate and talc may be included.

Examples of nutritionally acceptable carriers for use in preparing the forms include, for example, water, salt solutions, alcohol, silicone, waxes, petroleum jelly, vegetable oils, polyethylene glycols, propylene glycol, liposomes, sugars, gelatin, lactose, amylose, magnesium stearate, talc, surfactants, silicic acid, viscous paraffin, perfume oil, fatty acid monoglycerides and diglycerides, petroethral fatty acid esters, hydroxymethyl-cellulose, polyvinylpyrrolidone, and the like.

Preferred excipients for the forms include lactose, starch, a cellulose, milk sugar or high molecular weight polyethylene glycols.

For aqueous suspensions and/or elixirs, the feed additive composition may be combined with various sweetening or flavouring agents, colouring matter or dyes, with emulsifying and/or suspending agents and with diluents such as water, propylene glycol and glycerin, and combinations thereof.

Non-hydroscopic whey is often used as a carrier for DFMs (particularly bacterial DFMs) and is a good medium to initiate growth.

Bacterial DFM containing pastes may be formulated with vegetable oil and inert gelling ingredients.

Fungal products may be formulated with grain by-products as carriers.

In one embodiment preferably the feed additive composition is not in the form of a microparticle system, such as the microparticle system taught in WO2005/123034.

The DFM and/or feed additive composition may be designed for one-time dosing or may be designed for feeding on a daily basis.

The optimum amount of the feed additive composition (and each component therein) to be used in combination will depend on the product to be treated and/or the method of contacting the product with the composition and/or the intended use for the same.

The amount of DFM and enzymes used in the compositions should be a sufficient amount to be effective and to remain sufficiently effective in improving the performance of the animal fed feed products containing said composition. This length of time for effectiveness should extend up to at least the time of utilisation of the product (e.g. feed additive composition or feed containing same).

A feed additive composition of as described herein may be combined with (or one or more of the constituents thereof) and another component which is suitable for animal consumption and is capable of providing a medical or physiological benefit to the consumer.

In one embodiment preferably the “another component” is not a further enzyme or a further DFM.

The components may be prebiotics. Prebiotics are typically non-digestible carbohydrate (oligo- or polysaccharides) or a sugar alcohol which is not degraded or absorbed in the upper digestive tract. Known prebiotics used in commercial products and useful include inulin (fructo-oligosaccharide, or FOS) and transgalacto-oligosaccharides (GOS or TOS). Suitable prebiotics include palatinoseoligosaccharide, soybean oligosaccharide, alginate, xanthan, pectin, locust bean gum (LBG), inulin, guar gum, galacto-oligosaccharide (GOS), fructo-oligosaccharide (FOS), non-degradable starch, lactosaccharose, lactulose, lactitol, maltitol, maltodextrin, polydextrose (i.e. Litesse®), lactitol, lactosucrose, soybean oligosaccharides, palatinose, isomalto-oligosaccharides, gluco-oligosaccharides and xylo-oligosaccharides, pectin fragments, dietary fibres, mannan-oligosaccharides.

Dietary fibres may include non-starch polysaccharides, such as arabinoxylans, cellulose and many other plant components, such as resistant dextrins, inulin, lignin, waxes, chitins, pectins, beta-glucans and oligosaccharides.

In one embodiment disclosed herein are combination of the feed additive composition (or one or more of the constituents thereof) with a prebiotic. The prebiotic may be administered simultaneously with (e.g. in admixture together with or delivered simultaneously by the same or different routes) or sequentially to (e.g. by the same or different routes) the feed additive composition (or constituents thereof).

Other components of the combinations include polydextrose, such as Litesse®, and/or a maltodextrin and/or lactitol. These other components may be optionally added to the feed additive composition to assist the drying process and help the survival of DFM.

Further examples of other suitable components include one or more of: thickeners, gelling agents, emulsifiers, binders, crystal modifiers, sweeteners (including artificial sweeteners), rheology modifiers, stabilisers, anti-oxidants, dyes, enzymes, carriers, vehicles, excipients, diluents, lubricating agents, flavouring agents, colouring matter, suspending agents, disintegrants, granulation binders etc. These other components may be natural. These other components may be prepared by use of chemical and/or enzymatic techniques.

In one embodiment, the DFM comprising at least one bacterial strain and/or at least one protease may be encapsulated. In one embodiment the feed additive composition and/or DFM and/or enzymes is/are formulated as a dry powder or granule as described in WO2007/044968 (referred to as TPT granules)—reference incorporated herein by reference.

In one preferred embodiment, the DFM comprising at least one bacterial strain and/or at least one protease may be used in combination with one or more lipids.

For example, the DFM comprising at least one bacterial strain and/or at least one protease may be used in combination with one or more lipid micelles. The lipid micelle may be a simple lipid micelle or a complex lipid micelle. The lipid micelle may be an aggregate of orientated molecules of amphipathic substances, such as a lipid and/or an oil.

As used herein the term “thickener or gelling agent” refers to a product that prevents separation by slowing or preventing the movement of particles, either droplets of immiscible liquids, air or insoluble solids. Thickening occurs when individual hydrated molecules cause an increase in viscosity, slowing the separation. Gelation occurs when the hydrated molecules link to form a three-dimensional network that traps the particles, thereby immobilising them.

The term “stabiliser” as used here is defined as an ingredient or combination of ingredients that keeps a product (e.g. a feed product) from changing over time.

The term “emulsifier” as used herein refers to an ingredient (e.g. a feed ingredient) that prevents the separation of emulsions. Emulsions are two immiscible substances, one present in droplet form, contained within the other. Emulsions can consist of oil-in-water, where the droplet or dispersed phase is oil and the continuous phase is water; or water-in-oil, where the water becomes the dispersed phase and the continuous phase is oil. Foams, which are gas-in-liquid, and suspensions, which are solid-in-liquid, can also be stabilised through the use of emulsifiers.

As used herein the term “binder” refers to an ingredient (e.g. a feed ingredient) that binds the product together through a physical or chemical reaction. During “gelation” for instance, water is absorbed, providing a binding effect. However, binders can absorb other liquids, such as oils, holding them within the product. Binders would typically be used in solid or low-moisture products for instance baking products: pastries, doughnuts, bread and others.

“Carriers” or “vehicles” mean materials suitable for administration of the DFM and/or enzymes and include any such material known in the art such as, for example, any liquid, gel, solvent, liquid diluent, solubilizer, or the like, which is non-toxic and which does not interact with any components of the composition in a deleterious manner.

Examples of excipients include one or more of: microcrystalline cellulose and other celluloses, lactose, sodium citrate, calcium carbonate, dibasic calcium phosphate, glycine, starch, milk sugar and high molecular weight polyethylene glycols.

Examples of disintegrants include one or more of: starch (preferably corn, potato or tapioca starch), sodium starch glycollate, croscarmellose sodium and certain complex silicates.

Examples of granulation binders include one or more of: polyvinylpyrrolidone, hydroxypropylmethylcellulose (HPMC), hydroxypropylcellulose (HPC), sucrose, maltose, gelatin and acacia.

Examples of lubricating agents include one or more of: magnesium stearate, stearic acid, glyceryl behenate and talc.

Examples of diluents include one or more of: water, ethanol, propylene glycol and glycerin, and combinations thereof.

The other components may be used simultaneously (e.g. when they are in admixture together or even when they are delivered by different routes) or sequentially (e.g. they may be delivered by different routes).

Preferably, when the feed additive composition is admixed with another component(s), the DFM comprising at least one bacterial strain remains viable.

In one embodiment preferably the feed additive composition does not comprise chromium or organic chromium.

In one embodiment, preferably the feed additive does not contain glucanase.

In another embodiment, preferably the feed additive does not contain sorbic acid.

DFM(s) comprising at least one bacterial strain for may be in the form of concentrates. Typically these concentrates comprise a substantially high concentration of a DFM.

Feed additive compositions described herein may have a content of viable cells (colony forming units, CFUs) which is in the range of at least 10³ CFU/g (suitably including at least 10⁵ CFU/g, such as at least 10⁶ CFU/g, e.g. at least 10⁷ CFU/g, at least 10⁸ CFU/g, e.g. at least 10⁹ CFU/g) to about 10¹⁰ CFU/g (or even about 10¹¹ CFU/g or about 10¹² CFU/g).

When the DFM is in the form of a concentrate the feed additive compositions may have a content of viable cells in the range of at least 10⁹ CFU/g to about 10¹² CFU/g, preferably at least 10¹⁰ CFU/g to about 10¹² CFU/g.

Powders, granules and liquid compositions in the form of concentrates may be diluted with water or resuspended in water or other suitable diluents, for example, an appropriate growth medium such as milk or mineral or vegetable oils, to give compositions ready for use.

The feed additive composition may be in the form of concentrates may be prepared according to methods known in the art. Feed additive compositions described herein may be spray-dried or freeze-dried by methods known in the art.

Typical processes for making particles using a spray drying process involve a solid material which is dissolved in an appropriate solvent (e.g. a culture of a DFM in a fermentation medium). Alternatively, the material can be suspended or emulsified in a non-solvent to form a suspension or emulsion. Other ingredients (as discussed above) or components such as anti-microbial agents, stabilising agents, dyes and agents assisting with the drying process may optionally be added at this stage.

The solution then is atomised to form a fine mist of droplets. The droplets immediately enter a drying chamber where they contact a drying gas. The solvent is evaporated from the droplets into the drying gas to solidify the droplets, thereby forming particles. The particles are then separated from the drying gas and collected.

The term “subject”, as used herein, means an animal that is to be or has been administered with a feed additive composition or a feedstuff comprising said feed additive composition.

The term “subject”, as used herein, means an animal. Preferably, the subject is a mammal, bird, fish or crustacean including for example livestock or a domesticated animal (e.g. a pet).

In one embodiment the subject may be challenged by an enteric pathogen.

By way of example a subject may have one or more enteric pathogens present in its gut or digestive tract. For example a subject may have one or more enteric pathogens in its gut or digestive tract at a level which:

i) results in loss of performance of the animal; and/or

ii) is at clinically relevant levels; or

iii) is at sub-clinical levels.

The enteric pathogen may be Clostridium perfringens for example.

As used herein, “animal performance” may be determined by the feed efficiency and/or weight gain of the animal and/or by the feed conversion ratio and/or by the digestibility of a nutrient in a feed (e.g. amino acid digestibility) and/or digestible energy or metabolizable energy in a feed and/or by nitrogen retention and/or by animals ability to avoid the negative effects of necrotic enteritis and/or by the immune response of the subject.

Preferably “animal performance” is determined by feed efficiency and/or weight gain of the animal and/or by the feed conversion ratio.

By “improved animal performance” it is meant that there is increased feed efficiency, and/or increased weight gain and/or reduced feed conversion ratio and/or improved digestibility of nutrients or energy in a feed and/or by improved nitrogen retention and/or by improved ability to avoid the negative effects of necrotic enteritis and/or by an improved immune response in the subject resulting from the use of feed additive composition in feed in comparison to feed which does not comprise said feed additive composition.

Preferably, by “improved animal performance” it is meant that there is increased feed efficiency and/or increased weight gain and/or reduced feed conversion ratio.

As used herein, the term “feed efficiency” refers to the amount of weight gain in an animal that occurs when the animal is fed ad-libitum or a specified amount of food during a period of time.

By “increased feed efficiency” it is meant that the use of a feed additive composition in feed results in an increased weight gain per unit of feed intake compared with an animal fed without said feed additive composition being present.

As used herein, the term “feed conversion ratio” refers to the amount of feed fed to an animal to increase the weight of the animal by a specified amount.

An improved feed conversion ratio means a lower feed conversion ratio.

By “lower feed conversion ratio” or “improved feed conversion ratio” it is meant that the use of a feed additive composition in feed results in a lower amount of feed being required to be fed to an animal to increase the weight of the animal by a specified amount compared to the amount of feed required to increase the weight of the animal by the same amount when the feed does not comprise said feed additive composition.

Nutrient digestibility as used herein means the fraction of a nutrient that disappears from the gastro-intestinal tract or a specified segment of the gastro-intestinal tract, e.g. the small intestine. Nutrient digestibility may be measured as the difference between what is administered to the subject and what comes out in the faeces of the subject, or between what is administered to the subject and what remains in the digesta on a specified segment of the gastro intestinal tract, e.g. the ileum.

Nutrient digestibility as used herein may be measured by the difference between the intake of a nutrient and the excreted nutrient by means of the total collection of excreta during a period of time; or with the use of an inert marker that is not absorbed by the animal, and allows the researcher calculating the amount of nutrient that disappeared in the entire gastro-intestinal tract or a segment of the gastro-intestinal tract. Such an inert marker may be titanium dioxide, chromic oxide or acid insoluble ash. Digestibility may be expressed as a percentage of the nutrient in the feed, or as mass units of digestible nutrient per mass units of nutrient in the feed.

Nutrient digestibility as used herein encompasses starch digestibility, fat digestibility, protein digestibility, and amino acid digestibility.

Energy digestibility as used herein means the gross energy of the feed consumed minus the gross energy of the faeces or the gross energy of the feed consumed minus the gross energy of the remaining digesta on a specified segment of the gastro-intestinal tract of the animal, e.g. the ileum.

Metabolizable energy as used herein refers to apparent metabolizable energy and means the gross energy of the feed consumed minus the gross energy contained in the faeces, urine, and gaseous products of digestion. Energy digestibility and metabolizable energy may be measured as the difference between the intake of gross energy and the gross energy excreted in the faeces or the digesta present in specified segment of the gastro-intestinal tract using the same methods to measure the digestibility of nutrients, with appropriate corrections for nitrogen excretion to calculate metabolizable energy of feed. In some embodiments, the feed additive compositions can improve the digestibility or utilization of dietary hemicellulose or fibre in a subject. In some embodiments, the subject is a pig.

Nitrogen retention as used herein means as subject's ability to retain nitrogen from the diet as body mass. A negative nitrogen balance occurs when the excretion of nitrogen exceeds the daily intake and is often seen when the muscle is being lost. A positive nitrogen balance is often associated with muscle growth, particularly in growing animals. Nitrogen retention may be measured as the difference between the intake of nitrogen and the excreted nitrogen by means of the total collection of excreta and urine during a period of time. It is understood that excreted nitrogen includes undigested protein from the feed, endogenous proteinaceous secretions, microbial protein, and urinary nitrogen.

The term “survival” as used herein means the number of subject remaining alive. The term “improved survival” may be another way of saying “reduced mortality”.

The term “carcass yield” as used herein means the amount of carcass as a proportion of the live body weight, after a commercial or experimental process of slaughter. The term carcass means the body of an animal that has been slaughtered for food, with the head, entrails, part of the limbs, and feathers or skin removed. The term “meat yield” as used herein means the amount of edible meat as a proportion of the live body weight, or the amount of a specified meat cut as a proportion of the live body weight.

The present embodiment further provides a method of increasing weight gain in a subject, e.g. poultry or swine, comprising feeding said subject a feedstuff comprising a feed additive composition.

An “increased weight gain” refers to an animal having increased body weight on being fed feed comprising a feed additive composition compared with an animal being fed a feed without said feed additive composition being present.

Immune response as used herein means one of the multiple ways in which DFMs modulate the immune system of animals, including increased antibody production, up-regulation of cell mediated immunity, up-regulation of pro-inflammatory cytokines, and augmented toll-like receptor signalling. It is understood that immuno-stimulation of the gastro intestinal tract by DFMs may be advantageous to protect the host against disease, and that immuno-suppression of the gastro intestinal tract may be advantageous to the host because less nutrients and energy are used to support the immune function.

Preferably the immune response is a cellular immune response. that can be measured by looking at immune markers. In another aspect, populations of pathogens in the gastrointestinal tract of a subject may be reduced.

In one embodment, reduction of nutrient excretion in manure, or for reducing the production of ammonia in manure may be achieved. This has positive effects on reducing environmental hazards. For example, in a preferred embodiment to there is disclosed a method for reducing nitrogen and/or phosphorus content in the subject's manure. This, therefore, reduces the amount of nitrogen and/or phosphorus in the environment, which can be beneficial. For some applications, it is believed that the DFM comprising at least one bacterial strain in the feed additive composition described herein can exert a probiotic culture effect. It is also possible to add to this feed additive composition further probiotic and/or prebiotics.

Non-limiting examples of compositions and methods disclosed herein include:
1. A feed additive composition for consisting essentially of a direct fed microbial comprising one or more bacterial strains in combination with at least one protease.
2. The feed additive composition according of embodiment 1 wherein the direct fed microbial is an antipathogen direct fed microbial.
3. The feed additive composition of embodiments 1 or 2 wherein the direct fed microbial comprises at least three bacterial strains selected from the group consisting of: Lactobacillus, Lactococcus, Streptococcus, Bacillus, Pediococcus, Enterococcus, Leuconostoc, Carnobacterium, Propionibacterium, Bifidobacterium, Clostridium and Megasphaera and combinations thereof.
4. The feed additive composition of embodiment 3 wherein the direct-fed microbial comprises at least three bacterial strains selected from the group consisting of: Bacillus subtilis, Bacillus licheniformis, Bacillus pumilus, Bacillus amyloliquefaciens, Enterococcus, Enterococcus spp, and Pediococcus spp, Lactobacillus spp, Bifidobacterium spp, Lactobacillus acidophilus, Pediococsus acidilactici, Lactococcus lactis, Bifidobacterium bifidum, Propionibacterium thoenii, Lactobacillus farciminus, Lactobacillus rhamnosus, Clostridium butyricum, Bifidobacterium animalis ssp. animalis, Lactobacillus reuteri, Bacillus cereus, Lactobacillus salivarius ssp. salivarius, Megasphaera elsdenii, Propionibacteria sp and combinations thereof.
5. The feed additive composition of any embodiments 1, 2 or 4 wherein the direct-fed microbial comprises Bacillus subtilis strains 3BP5 (NRRL B-50510); 918 (NRRL B-50508), and 1013 (NRRL B-50509).
6. The feed additive composition of embodiments 1, 2 or 4 wherein the direct fed microbial is in the form of an endospore.
7. The feed additive composition of embodiment 5 wherein the direct fed microbial is in the form of an endospore.
8. The feed additive composition of embodiments 1, 2, 4 or 7 wherein the protease is a subtilisin, a bacillolysin, an alkaline serine protease, a keratinase or a Nocardiopsis protease.
9. The feed additive composition of embodiment 6 wherein the protease is a subtilisin, a bacillolysin, an alkaline serine protease, a keratinase or a Nocardiopsis protease.
10. The feed additive composition of composition according of any of claim 1, 2, 4 or 7 wherein the protease is a subtilisin from Bacillus amyloliquefaciens.
11. The feed additive composition of embodiment 6 wherein the protease is a subtilisin from Bacillus amyloliquefaciens.
12. The feed additive composition of any of embodiments 1, 2, 4, or 7 wherein the protease is present at a dosage of 1000 PU/g feed additive composition to 200,000 PU/g feed additive composition.
13. The feed additive composition of embodiment 6 wherein the protease is present at a dosage of 1000 PU/g feed additive composition to 200,000 PU/g feed additive composition.
14. The feed additive composition of any of embodiments 1, 2, 4, or 7 wherein the DFM is present at a dosage of 1×10³ CFU/g feed additive composition to 1×10¹³ CFU/g feed additive composition.
15. The feed additive composition of any of embodiment 6 wherein the DFM is present at a dosage of 1×10³ CFU/g feed additive composition to 1×10¹³ CFU/g feed additive composition.
16. A method for improving the performance of a subject or for improving digestibility of a raw material in a feed (e.g. nutrient digestibility, such as amino acid digestibility), or for improving nitrogen retention, or for improving the subjects resistance to necrotic enteritis or for improving feed conversion ratio (FCR) or for increasing the carcass or meat yield or for improving body weight gain in a subject or for improving feed efficiency in a subject or for modulating (e.g. improving) the immune response of the subject, or for promoting the growth of beneficial bacteria in the gastrointestinal tract of a subject or for reducing populations of pathogenic bacteria in the gastrointestinal tract of a subject, or for reducing nutrient excretion in manure, or for reducing the production of ammonia in manure, or for improving the digestibility or utilization of dietary hemicellulose or fibre, which method comprising administering a direct-fed microbial comprising one or more bacterial strains in combination with at least one protease.
17. A kit comprising the feed additive composition of embodiment 1 and instructions for administration.
18. A method of preparing a feed additive composition, comprising admixing a direct-fed microbial comprising one or more bacterial strains in combination with at least one protease and packaging.
19. A feed comprising the feed additive composition of embodiments 1, 2, 4 or 7
20. A feed comprising the feed additive composition of embodiment 6.
21. A premix comprising a feed additive composition of embodiment land at least one mineral and/or at least one vitamin.

### EXAMPLES

Unless defined otherwise herein, all technical and scientific terms used herein have the same meaning as commonly understood by one of ordinary skill in the art to which this disclosure belongs. Singleton, et al., DICTIONARY OF MICROBIOLOGY AND MOLECULAR BIOLOGY, 2D ED., John Wiley and Sons, New York (1994), and Hale & Marham, THE HARPER COLLINS DICTIONARY OF BIOLOGY, Harper Perennial, N.Y. (1991) provide one of skill with a general dictionary of many of the terms used with this disclosure.

The disclosure is further defined in the following Examples. It should be understood that the Examples, while indicating certain embodiments, is given by way of illustration only. From the above discussion and the Examples, one skilled in the art can ascertain essential characteristics of this disclosure, and without departing from the spirit and scope thereof, can make various changes and modifications to adapt to various uses and conditions.

### Example 1

### Effects of a Three-Strain Bacillus Based Direct Fed Microbial (Bacillus Strains 3BP5, 918, 1013) and Protease when Fed Singly or in Combination on the Growth Performance and Total Tract Digestibility of Nutrients in Pigs Fed Corn Based Diets

### Materials and Methods

### Housing and Environment

The use of animals and experimental protocol is approved by the Animal Experiment Committee. The basal diet, as fed, is formulated to be balanced for energy and protein, and to meet or exceed the nutrient requirements for growing pigs of this age (Table 1) as recommended by the NRC (2012). A common digestibility marker (chromic oxide) is included at 0.30% to allow determination of digestibility of dietary components.

The basal diet is divided into portions which are then treated with the enzymes or direct fed microbials (DFMs) or a combination of both as identified in Table 2. During feed mixing, the mixer is flushed to prevent cross contamination of diet. Samples are collected from each treatment diet from the beginning, middle, and end of each batch and blended together to confirm enzyme activities and DFM counts in feed. Samples from each treatment diet are retained during mixing and stored at −20° C. until required.

TABLE 1
Examples of basal diet composition for pigs
20 to 50 kg body weight (%, as-fed)

| Items | Basal diet |
|---|---|
| Ingredients, % | |
| Corn | 42.33 |
| Corn distiller's dried grains with solubles | 20.00 |
| Soybean meal | 19.88 |
| Rapeseed meal | 2.00 |
| Wheat | 5.00 |
| Rice bran | 3.00 |
| Tallow | 2.00 |
| Molasses | 3.00 |
| L-lysine HCl | 0.24 |
| DL-methionine | 0.02 |
| Salt | 0.30 |
| Limestone | 1.18 |
| Di-calcium phosphate | 0.45 |
| Vitamins¹ and mineral² premix | 0.30 |
| Chromic oxide | 0.30 |
| Total | 100.00 |
| Calculated composition | |
| Dry matter, % | 87.55 |
| Crude protein, % | 19.24 |
| Digestbible energy, MJ/kg | 14.61 |
| Standardized ileal digestible lysine, % | 0.91 |
| Standardized ileal digestible Methionine, % | 0.30 |
| Standardized ileal digestible methionine | 0.55 |
| and cystenine, % | |
| Standardized ileal digestible threonine, % | 0.54 |
| Standardized ileal digestible tryptophan, % | 0.16 |
| Neutral detergent fiber, % | 17.59 |
| Acid detergent fiber, % | 5.97 |
| Calcium, % | 0.72 |
| Digestible phosphorous, % | 0.33 |
| Analyzed composition | |
| Dry matter, % | 88.23 |
| Crude protein, % | 19.56 |
| Neutral detergent fiber, % | 17.16 |
| Acid detergent fiber, % | 5.75 |

¹Supplied per kilogram diet: vitamin A, 10,000 IU; vitamin D₃, 1,300 IU; vitamin E, 40 IU; vitamin K (menadione bisulfate complex), 3.0 mg; vitamin B₂, 5.2 mg; vitamin B₆, 2.6 mg; vitamin B₁₂, 26 μg; niacin, 32 mg; and d-pantothenic acid (as d-calcium pantothenate), 20 mg.
²Supplied per kilogram diet: Cu (as CuSO₄•5H₂O), 19 mg; Fe (as FeSO₄•7H₂O), 70 mg; Zn (as ZnSO₄), 50 mg; Mn (as MnO₂), 50 mg; I (as KI), 0.5 mg; Co (as CoSO₄•7H2O), 0.3 mg; and Se (as Na₂SeO₃•5H₂O), 0.2 mg.
³The ME of the diet was calculated according to NRC (2012).

TABLE 2
Experimental diets identification

| | | DFM, CFU or | Enzyme, |
|---|---|---|---|
| Treatment | Description | FU*/g of feed | U/kg of feed |
| 1 | Control, basal (NC) | N/A | N/A |
| 2 | NC + DFM¹ | 1.5 × 10⁵ | N/A |
| 3 | NC + Protease² | N/A | 6000 |
| 4 | NC + DFM + Protease | 1.5 × 10⁵ | 6000 |

¹3 strains of Bacillus: Bacillus strains 3BP5, 918 and 1013
²Protease: Bacillus amyloliquefaciens protease P3000

The experiment is planned and conducted to correspond to growing phase (≤25 to ˜60 kg body weight).

### Experimental Design

A total of 96 growing pigs [(Yorkshire×Landrace)×Duroc] with an average BW of 22.6±1.9 kg are used in 42 day experiment. Pigs are randomly allotted to 4 experiment diets according to their initial BW. There are 8 replicate pens per treatment with 3 pigs per pen. Barrows and gilts are separated with four pens of barrows and four pens of gilts in each treatment. All pigs are housed in an environmentally-controlled room. Each pen is equipped with a one-sided, stainless steel self-feeder and a nipple drinker that pigs are allowed access to feed and water ad libitum.

### Growth Performance and Fecal Sample Collection and Analysis

Body weight and feed consumption is measured weekly to monitor the average daily gain (ADG), average daily feed intake (ADFI) and feed conversion ratio (FCR). Apparent total tract digestibility (ATTD, %) of GE and N is determined by adding chromic oxide (0.3%) as an inert indicator in the diet. Pigs are fed diets mixed with chromic oxide one week before the end of the trial (day 35). Fresh fecal grab samples are collected from at least 2 pigs per pen by rectal massage (day 40, 41 and 42) and stored in a freezer at −20° C. until analysed. Before chemical analysis, the fecal samples are thawed and dried at 60° C. for 72 h, after which they are finely ground to a size that could pass through a 1-mm screen. All feed and fecal samples are, then, analysed for dry matter, gross energy, nitrogen, acid detergent fiber (ADF) and neutral detergent fiber (NDF) following the procedures outlined by the AOAC (2000). Chromium is analysed via UV absorption spectrophotometry (Shimadzu, UV-1201, Shimadzu, Kyoto, Japan) following the method described by Williams et al. (1962). Crude protein apparent total tract digestibility is calculated by multiplying nitrogen by a conversion factor of 6.25. The improvements in digestible energy (kcal) with the addition of each feed additive compared to the negative control were calculated by the following equations;

Analysed dietary GE (kcal/kg)/100*ATTD of energy=Digestible energy as fed (kcal/kg) 1.

Digestible energy improvement (kcal/kg)=average Digestible energy as fed (kcal/kg) of NC group−Average Digestible energy as fed (kcal/kg) of DFM+protease replicate 2.

All data were subjected to the statistical analysis as a randomized complete block design using the Mixed procedures of SAS (SAS Inst. Inc., Cary, N.C.), and the pen was used as the experimental unit. The initial BW was used as a covariate for ADFI and ADG. Significance is embodimented at P<0.05.

### Growth Performance:

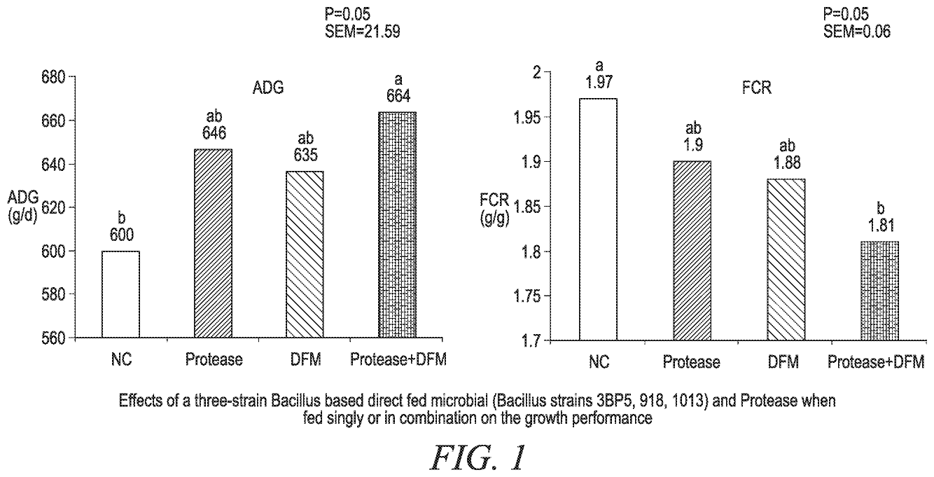

Supplementation of a corn-based diet with a combination of a DFM (Bacillus) and protease significantly improves the average daily gain and feed conversion efficiency ratio (P<0.05) compared to the negative control basal diet without any feed additives (FIG. 1). The addition of DFM (Bacillus) and protease singly to corn-based diets did not significantly improve average daily gain or feed conversion efficiency ratio compared to the negative control diet.

### Apparent Total Tract Digestibility of Nutrients:

The apparent total tract digestibility of dry matter, nitrogen, digestible energy, acid detergent fiber and neutral detergent fiber are all significantly improved with the supplementation of the DFM in combination with the protease compared to the negative control diet (Table 3; P<0.05). This improvement in nutrient digestibility as a result of feeding the DFM+protease combination equated to 3% for nitrogen, 9% for ADF and 3.5% for NDF compared to the negative control diet. However, when supplemented singly, there is no difference in apparent total tract digestibility of dry matter, nitrogen, digestible energy, acid detergent fiber and neutral detergent fiber between the negative control diet and either the DFM or protease treatments. The combination of DFM and protease increased the digestible energy of the diet by 56.8 kcal/kg compared to the negative control diet (P<0.05) while the additives when added singly depressed the energy digestibility of the diet.

TABLE 3
Effects of a three-strain Bacillus based direct fed microbial (Bacillus
strains 3BP5, 918, 1013) and Protease (P3000) when fed singly or
in combination on the apparent total tract digestibility of nutrients

| | NC | DFM | Protease | DFM + Protease | SE |
|---|---|---|---|---|---|
| Dry Matter, % | 80.39^{a} | 80.21^{a} | 80.59^{a} | 82.07^{b} | 0.41 |
| Nitrogen, % | 77.40^{a} | 78.11^{ab} | 77.74^{a} | 80.29^{c} | 0.51 |
| DE, % | 79.32^{ab} | 78.10^{a} | 76.56^{a} | 80.53^{bc} | 0.47 |
| ADF¹, % | 44.17^{a} | 46.87^{a} | 48.64^{ab} | 53.30^{bc} | 1.65 |
| NDF², % | 61.08^{a} | 61.73^{a} | 61.18^{a} | 64.80^{b} | 0.40 |
| DE, kcal/kg ³ | | −128.3 | −56.7 | +56.8 | |

^{a,b,c}Mean in the same row with different superscripts differ (P < 0.05)
¹ADF: acid detergent fiber
²NDF: neutral detergent fiber
³ DE (digestbile energy): The difference in digestible energy (kcal/kg) relative to the negative control diet.

### Example 2

### Effects of a Three-Strain Bacillus Based Direct Fed Microbial (Bacillus Strains 3BP5, 918, 1013) and Protease when Fed Singly or in Combination on the Growth Performance, Total Tract Digestibility of Nutrients and Fecal Ammonia Excretion in Pigs Fed Corn Based Diets

### Materials and Methods

### Housing and Environment

The use of animals and experimental protocol is approved by the Animal Experiment Committee. The basal diet, as fed, is formulated to be balanced for energy and protein, and to meet or exceed the nutrient requirements for growing pigs of this age (Table 2.1) as recommended by the NRC (2012). A common digestibility marker (chromic oxide) is included at 3 g/kg to allow determination of digestibility of dietary components.

The basal diet is divided into portions which are then treated with the enzymes or direct fed microbials (DFMs) or a combination of both as identified in Table 2.2. During feed mixing, the mixer is flushed to prevent cross contamination of diet. Samples are collected from each treatment diet from the beginning, middle, and end of each batch and blended together to confirm enzyme activities and DFM counts in feed. Samples from each treatment diet are retained during mixing and stored at −20° C. until required.

TABLE 2.1
Examples of basal diet composition for pigs
20 to 50 kg body weight (%, as-fed)

| Items | Basal diet |
|---|---|
| Ingredients, % | |
| Corn | 55.61 |
| Wheat feed | 11.06 |
| Corn distiller's dried grains with solubles (DDGS | 5.00 |
| Soybean meal | 19.08 |
| Rapeseed meal | 2.00 |
| Cottonseed meal | 4.00 |
| DL-methionine | 0.05 |
| L-threonine | 0.05 |
| Chromic oxide | 0.30 |
| Biolys 60 | 0.25 |
| Bentonite | 0.50 |
| Sodium bicarbonate | 0.10 |
| Salt | 0.30 |
| Limestone | 0.72 |
| Dicalcium phosphate | 0.42 |
| Choline chloride 50% | 0.05 |
| Pig Vitamnins¹/trace elements² premix | 0.50 |
| Axtra PHY3 (0.12 P; 0.093 Ca) | 0.01 |
| Total | 100.00 |
| Calculated Composition | |
| Dry matter, % | 88.28 |
| Crude protein, % | 19.03 |
| Digestible energy, MJ/kg | 13.39 |
| Standardized ileal digestible lysine, % | 0.86 |
| Standardized ileal digestible methionine, % | 0.33 |
| Standardized ileal digestible methionine | 0.56 |
| a and cysteine, % | |
| Standardized ileal digestible threonine, % | 0.56 |
| Standardized ileal digestible tyrptophan, % | 0.16 |
| Neutral detergent fiber, % | 15.64 |
| Calcium, % | 0.66 |
| DigestiblePhosphorous, % | 0.31 |

¹Supplied per kilogram diet: vitamin A, 10,000 IU; vitamin D₃, 1,300 IU; vitamin E, 40 IU; vitamin K (menadione bisulfate complex), 3.0 mg; vitamin B₂, 5.2 mg; vitamin B₆, 2.6 mg; vitamin B₁₂, 2.6 μg; niacin, 32 mg; and d-pantothenic acid (as d-calcium pantothenate), 20 mg.
²Supplied per kilogram diet: Cu (as CuSO₄•5H₂O), 19 mg; Fe (as FeSO₄•7H₂O), 70 mg; Zn (as ZnSO₄), 50 mg; Mn (as MnO₂), 50 mg; I (as KI), 0.5 mg; Co (as CoSO₄•7H₂O), 0.3 mg; and Se (as Na₂SeO₃•5H₂O), 0.2 mg.
³Supplemental phytase (Danisco UK Ltd)

TABLE 2.2
Experimental diets identification

| | | DFM, CFU or FU*/g | Enzyme, |
|---|---|---|---|
| Treatment | Description | of feed | U/kg of feed |
| 1 | Control, basal (NC) | N/A | N/A |
| 2 | NC + DFM¹ | 1.5 × 10⁵ | N/A |
| 3 | NC + Protease² | N/A | 5000 |
| 4 | NC + DFM + Protease | 1.5 × 10⁵ | 5000 |

¹3 strains of Bacillus: Bacillus strains 3BP5, 918 and 1013
²Protease: Bacillus amyloliquefaciens protease P3000

The experiment is planned and conducted to correspond to growing phase (≤25 to ˜60 kg body weight).

### Experimental Design

A total of 128 growing pigs [(Yorkshire×Landrace)×Duroc] with an average BW of 24.99±1.84 kg are used in 42 day experiment. Pigs are randomly allotted to 4 experiment diets according to their initial BW. There are 8 replicate pens per treatment with 4 pigs per pen. Barrows and gilts are separated with four pens of barrows and four pens of gilts each treatment. All pigs are housed in an environmentally-controlled room. Each pen is equipped with a one-sided, stainless steel self-feeder and a nipple drinker that pigs are allowed access to feed and water ad libitum.

### Growth Performance and Fecal Sample Collection and Analysis

Body weight and feed consumption is measured weekly to monitor the average daily gain (ADG), average daily feed intake (ADFI) and feed conversion ratio (FCR). Apparent total tract digestibility (ATTD) of GE and N is determined by adding chromic oxide (0.3%) as an inert indicator in the diet. Pigs are fed diets mixed with chromic oxide throughout the trial. Fresh fecal grab samples are collected from at least 2 pigs per pen by rectal massage (day 21 and 42) and stored in a freezer at −20° C. until analysed. Before chemical analysis, the fecal samples are thawed and dried at 60° C. for 72 h, after which they are finely ground to a size that could pass through a 1-mm screen. All feed and fecal samples are then, analysed for dry matter, gross energy, nitrogen, acid detergent fiber (ADF) and neutral detergent fiber (NDF) following the procedures outlined by the AOAC (2000). Chromium is analysed via UV absorption spectrophotometry (Shimadzu, UV-1201, Shimadzu, Kyoto, Japan) following the method described by Williams et al. (1962). Crude protein apparent total tract digestibility was calculated by multiplying nitrogen by a conversion factor of 6.25. The improvements in digestible energy (kcal) with the addition of each feed additive compared to the negative control were calculated by the following equations;

Analysed dietary GE (kcal/kg)/100*ATTD of energy=Digestible energy as fed (kcal/kg) 1.

Digestible energy improvement (kcal/kg)=average Digestible energy as fed (kcal/kg) of NC group−Average Digestible energy as fed (kcal/kg) of DFM+protease replicate 2.

### Fecal Ammonia Emission

For analysis of the fecal NH₃ concentration, 300 g of fresh fecal samples are collected from at least two pigs per pen and are transferred to a sealed box and fermented in an incubator (35° C.). The NH₃ concentration is then analysed using a gas search probe (Gastec Corp., Kanagawa, Japan) at day 7.

### Statistical Analysis

All data were subjected to the statistical analysis as a randomized complete block design using the Mixed procedures of SAS (SAS Inst. Inc., Cary, N.C.), and the pen was used as the experimental unit. The initial BW was used as a covariate for ADFI and ADG. Significance is embodimented at P<0.05.

### Results

### Growth Performance:

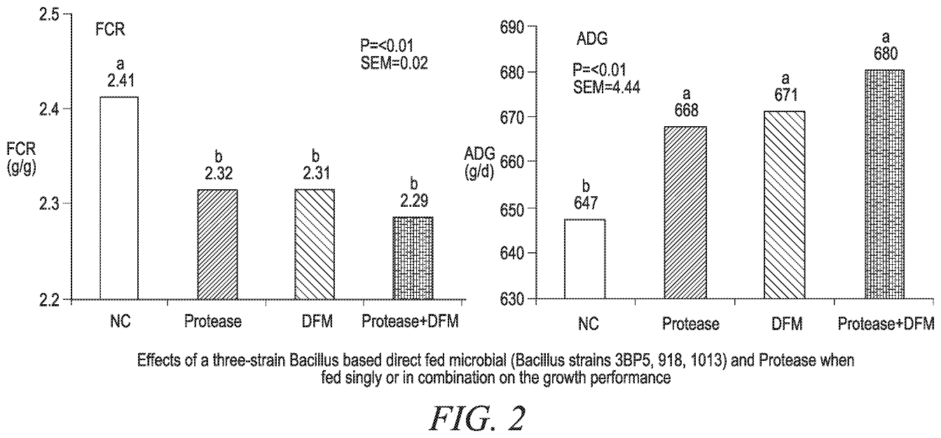

Supplementation of a corn-based diet with a combination of a DFM (Bacillus) and protease significantly improves the average daily gain and feed conversion efficiency ratio (P<0.05) compared to the negative control basal diet without any feed additives (FIG. 2). The addition of DFM (Bacillus) and protease singly to corn-based diets also improve averaged daily gain and feed conversion efficiency ratio (P<0.05) compared to the negative control diet however; the magnitude of the improvement was less than was seen for the combination of the protease+DFM.

### Apparent Total Tract Digestibility of Nutrients:

Both on day 21 and 42, the apparent total tract digestibility of dry matter and crude protein are improved with the supplementation of the DFM in combination with the protease compared to the negative control diet (Table 2.3; P<0.05). This improvement in nutrient digestibility as a result of feeding the DFM+protease combination equated to 5% for dry matter, 5% for nitrogen, and 2% for both NDF and ADF compared to the negative control diet on day 21 and 5% for dry matter, 6% for nitrogen, 6% for ADF and 2% for NDF compared to the negative control diet on day 42. However, when supplemented singly, there is no difference in apparent total tract digestibility of dry matter and nitrogen between the negative control diet and either the DFM or protease treatments (P>0.05). On day 21, the protease and DFM treatment resulted in numerically higher apparent total tract digestibility of digestible energy, ADF and NDF than all other treatments. On day 42, the combination of protease and DFMs numerically increased the apparent total tract digestibility of digestible energy, NDF and ADF. A synergist response in digestible energy was observed between the protease and DFMs whereby the combination released an additional 181.3 kcal/kg compared to the negative control diet and this value was greater than the sum of the additional digestible energy that could be attributed to the DFMs or protease alone.

TABLE 2.3
Effects of a three-strain Bacillus based direct fed
microbial (Bacillus strains 3BP5, 918, 1013)
and Protease when fed singly or in combination on the
apparent total tract digestibility of nutrients.

| | NC | DFM | Protease | DFM + Protease | SE |
|---|---|---|---|---|---|
| Day 21 | | | | | |
| Dry Matter, % | 76.70^{b} | 77.92^{ab} | 78.37^{ab} | 81.67^{a} | 1.26 |
| Nitrogen, % | 75.85^{b} | 76.77^{b} | 76.54^{b} | 80.96^{a} | 1.06 |
| Gross energy, % | 77.94 | 75.14 | 76.09 | 79.39 | 1.40 |
| ADF¹, % | 50.12 | 50.01 | 49.73 | 52.41 | 2.54 |
| NDF², % | 59.29 | 58.71 | 58.64 | 61.05 | 1.93 |
| Day 42 | | | | | |
| Dry Matter, % | 73.54^{b} | 74.49^{ab} | 73.63^{b} | 78.84^{a} | 1.58 |
| Nitrogen, % | 75.06^{b} | 75.72^{b} | 75.41^{b} | 81.38^{a} | 1.67 |
| Gross energy, % | 75.53 | 75.21 | 75.74 | 77.54 | 1.54 |
| ADF¹, % | 47.48^{b} | 53.52^{a} | 54.39^{a} | 53.66^{a} | 2.54 |
| NDF², % | 60.00 | 62.53 | 62.14 | 62.02 | 1.98 |
| DE, kcal/kg ³ | | +101.7 | +10.3 | +181.3 | |

^{a,b,c}Mean in the same row with different superscripts differ (P < 0.05)
¹ADF: acid detergent fiber
²NDF: neutral detergent fiber
³ DE: The difference in digestible energy (kcal/kg) relative to the negative control diet.

### Fecal Ammonia Emissions

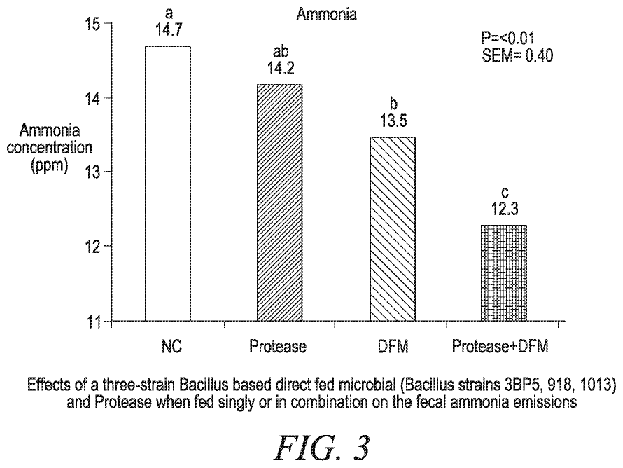

The addition of protease alone to a corn based diet did not decrease fecal ammonia emissions compared to the negative control or DFM alone treatment (FIG. 3). Compared to the negative control treatment, feeding DFM alone decreased ammonia emissions (P<0.05). However, when a combination of protease and DFM were fed to pigs, a synergist response was evident whereby the magnitude of reduction in ammonia emissions was greater (17% reduction in ammonia concentration compared to the negative control) than the sum of the reduction that could be attributed to the individual treatments alone (P<0.05).

### Example 3

### Effects of a Three-Strain Bacillus Based Direct Fed Microbial (Bacillus Strains 3BP5, 918, 1013) and Protease when Fed Singly or in Combination on the Growth Performance and Total Tract Digestibility of Nutrients in Pigs Fed Corn Based Diets

### Materials and Methods

### Housing and Environment

The use of animals and experimental protocol is approved by the Animal Experiment Committee. The basal diet, as fed, is formulated to be balanced for energy and protein, and to meet or exceed the nutrient requirements for growing pigs of this age (Table 3.1) as recommended by the NRC (2012). A common digestibility marker (chromic oxide) is included at 3 g/kg to allow determination of digestibility of dietary components.

The basal diet is divided into portions which are then treated with the enzymes or direct fed microbials (DFMs) or a combination of both as identified in Table 3.2. During feed mixing, the mixer is flushed to prevent cross contamination of diet. Samples are collected from each treatment diet from the beginning, middle, and end of each batch and blended together to confirm enzyme activities and DFM counts in feed.

TABLE 3.1
Examples of basal diet composition for pigs
20 to 50 kg body weight (%, as-fed)

| Items | Basal diet |
|---|---|
| Ingredients, % | |
| Corn | 52.94 |
| Soybean Meal, | 18.20 |
| Rice bran, | 12.50 |
| Wheat bran | 7.83 |
| Molasses, | 2.50 |
| Fish meal, | 1.50 |
| Fish fat | 1.00 |
| Meat and bone meal | 1.00 |
| Calcium carbonate fine | 0.75 |
| Salt | 0.68 |
| Organic acid (fumaric, citric, maleic) | 0.30 |
| Vitamins and trace elemenyspremix^{1,2} | 0.25 |
| Klino feed (clay) | 0.20 |
| L-lysine HCL | 0.17 |
| DL-methionine | 0.05 |
| Dicalciumfosfate, 17% | 0.05 |
| Choline chloride 60% veg carrier | 0.05 |
| L-Threonine, 95.8% | 0.03 |
| Total | 100.00 |
| Calculated composition | |
| Dry matter, % | 86.56 |
| Crude protein, % | 17.13 |
| Apparent ileal digestible lysine, % | 0.82 |
| Apparent ileal digestible methionine, % | 0.29 |
| Apparent ileal digestible methionine | 0.50 |
| and and cysteine, % | |
| Apparent ileal digestible threonine, % | 0.49 |
| Apparent ileal digestible tryptophan, % | 0.15 |
| Calcium, % | 0.89 |
| Digestible phosphorous, % | 1.30 |

¹Supplied per kilogram diet: vitamin A, 10,000 IU; vitamin D₃, 1,300 IU; vitamin E, 40 IU; vitamin K (menadione bisulfate complex), 3.0 mg; vitamin B₂, 5.2 mg; vitamin B₆, 2.6 mg; vitamin B₁₂, 26 μg; niacin, 32 mg; and d-pantothenic acid (as d-calcium pantothenate), 20 mg.
²Supplied per kilogram diet: Cu (as CuSO₄•5H₂O), 19 mg; Fe (as FeSO₄•7H₂O), 70 mg; Zn (as ZnSO₄), 50 mg; Mn (as MnO₂), 50 mg; I (as KI), 0.5 mg; Co (as CoSO₄•7H₂O), 0.3 mg; and Se (as Na₂SeO₃•5H₂O), 0.2 mg.

TABLE 3.2
Experimental diets identification

| | | DFM, CFU or FU*/g | Enzyme, |
|---|---|---|---|
| Treatment | Description | of feed | U/kg of feed |
| 1 | Control, basal (NC) | N/A | N/A |
| 2 | NC + DFM¹ | 1.5 × 10⁵ | N/A |
| 3 | NC + Protease² | N/A | 5000 |
| 4 | NC + DFM + Protease | 1.5 × 10⁵ | 5000 |

¹3 strains of Bacillus: Bacillus strains 3BP5, 918 and 1013
²Protease: Bacillus amyloliquefaciens protease P3000

The experiment is planned and conducted to correspond to growing phase (≤25 to ˜60 kg body weight).

### Experimental Design

A total of 128 growing pigs [(Yorkshire×Landrace)×Duroc] are used in 42 day experiment. Pigs are randomly allotted to 4 experiment diets according to their initial BW. There are 8 replicate pens per treatment with 3 pigs per pen. Barrows and gilts are separated with four pens of barrows and four pens of gilts each treatment. All pigs are housed in an environmentally-controlled room. Each pen is equipped with a one-sided, stainless steel self-feeder and a nipple drinker that pigs are allowed access to feed and water ad libitum.

### Growth Performance and Fecal Sample Collection and Analysis

Body weight and feed consumption is measured weekly to monitor the average daily gain (ADG), average daily feed intake (ADFI) and feed conversion ratio (FCR). Apparent total tract digestibility (ATTD) of GE and N is determined by adding chromic oxide (0.3%) as an inert indicator in the diet. Pigs are fed diets mixed with chromic oxide for the duration of the trial. Fresh fecal grab samples are collected from at least 2 pigs per pen by rectal massage (day 21 and 42) and stored in a freezer at −20° C. until analysed. Before chemical analysis, the fecal samples are thawed and dried at 60° C. for 72 h, after which they are finely ground to a size that could pass through a 1-mm screen. All feed and fecal samples are, then, analysed for dry matter, gross energy, nitrogen, acid detergent fiber (ADF) and neutral detergent fiber (NDF) following the procedures outlined by the AOAC (2000). Chromium is analysed via UV absorption spectrophotometry (Shimadzu, UV-1201, Shimadzu, Kyoto, Japan) following the method described by Williams et al. (1962). Crude protein apparent total tract digestibility was calculated by multiplying nitrogen by a conversion factor of 6.25. The improvements in digestible energy (kcal) with the addition of each feed additive compared to the negative control were calculated by the following equations;

Analysed dietary GE (kcal/kg)/100*ATTD of energy=Digestible energy as fed (kcal/kg) 1.

Digestible energy improvement (kcal/kg)=average Digestible energy as fed (kcal/kg) of NC group−Average Digestible energy as fed (kcal/kg) of DFM+protease replicate 2.

### Fecal Ammonia Concentration

For analysis of the fecal NH₃ concentration, 300 g of fresh fecal samples are collected from at least two pigs per pen and are transferred to a sealed box and fermented in an incubator (35° C.). The NH₃ concentration is then analysed using a gas search probe (Gastec Corp., Kanagawa, Japan) at day 7.

### Statistical Analysis

All data were subjected to the statistical analysis as a randomized complete block design using the Mixed procedures of SAS (SAS Inst. Inc., Cary, N.C.), and the pen was used as the experimental unit. The initial BW was used as a covariate for ADFI and ADG. Significance is embodimented at P<0.05.

### Results

### Growth Performance:

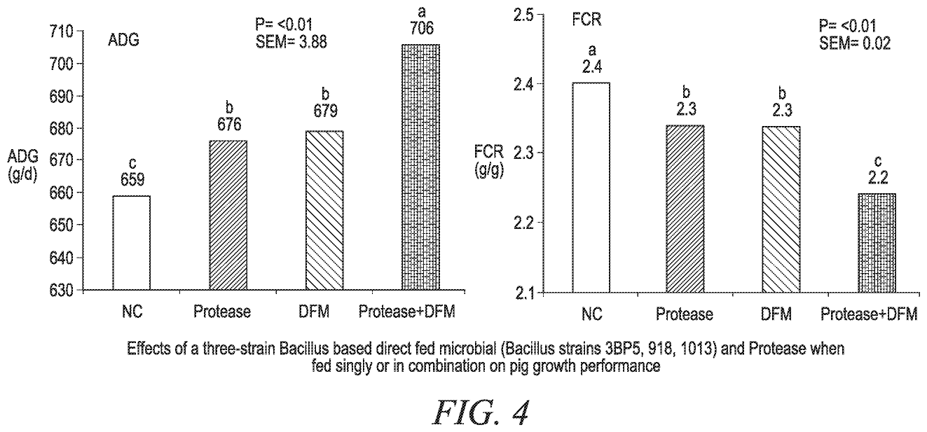

Supplementation of a corn-based diet with a combination of a DFM (Bacillus) and protease significantly improves the average daily gain and feed conversion efficiency ratio (P<0.05) compared to the negative control basal diet without any feed additives (FIG. 4). The addition of DFM (Bacillus) and protease singly to corn-based diets also improve averaged daily gain and feed conversion efficiency ratio (P<0.05) compared to the negative control diet however; the magnitude of the improvement was significantly less (P<0.05) than was seen for the combination of the protease+DFM.

### Apparent Total Tract Digestibility of Nutrients:

Both on day 21 and 42, the apparent total tract digestibility of dry matter and nitrogen are improved with the supplementation of the DFM in combination with the protease compared to the negative control diet and the additives fed singly (Table 3.3; P<0.05). This improvement in nutrient digestibility as a result of feeding the DFM+protease combination equated to 3% for dry matter, 5.5% for ADF, and 4.5% for both NDF and nitrogen compared to the negative control diet on day 21 and 3% for dry matter, 4% for nitrogen, 6% for ADF and 3.5% for NDF compared to the negative control diet on day 42. On day 21, the protease and DFM treatment resulted in numerically higher apparent total tract digestibility of digestible energy and ADF than all other treatments. Also, on day 21, the DFM+protease combination significantly increased the apparent total tract digestibility of NDF compared to the negative control and protease alone treatment. On day 42, the combination of protease and DFMs numerically increased the apparent total tract digestibility of NDF and ADF compared to all other treatments. In addition, the DFM+protease combination significantly increase the apparent total tract digestibility of energy compared to the negative control and protease along treatments (P<0.05). The additional digestible energy (kcal/kg) released by the DFM+protease treatment was greater than the digestible energy released from the DFM or protease alone treatments.

TABLE 3.3
Effects of a three-strain Bacillus based direct fed microbial
(Bacillus strains 3BP5, 918, 1013)
and Protease when fed singly or in combination on the
apparent total tract digestibility of nutrients.

| | NC | DFM | Protease | DFM + Protease | SE |
|---|---|---|---|---|---|
| Day 21 | | | | | |
| Dry Matter, % | 78.57^{b} | 80.31^{b} | 80.07^{b} | 81.52^{a} | 0.32 |
| Nitrogen, % | 76.99^{c} | 79.02^{b} | 78.94^{b} | 81.64^{a} | 0.62 |
| Gross energy, % | 78.45 | 78.44 | 78.46 | 79.87 | 0.45 |
| ADF¹, % | 48.56 | 51.55 | 50.91 | 53.94 | 2.09 |
| NDF², % | 56.02^{c} | 58.44^{ab} | 57.23^{bc} | 60.43^{a} | 0.81 |
| Day 42 | | | | | |
| Dry Matter, % | 75.35^{c} | 76.88^{b} | 76.04^{bc} | 78.33^{a} | 0.46 |
| Nitrogen, % | 72.56^{c} | 74.58^{b} | 73.88^{bc} | 76.34^{a} | 0.52 |
| Gross energy, % | 73.18^{c} | 75.77^{ab} | 74.58^{b} | 77.28^{a} | 0.59 |
| ADF¹, % | 50.06 | 51.90 | 51.38 | 55.97 | 2.20 |
| NDF², % | 57.10 | 59.81 | 58.16 | 60.60 | 0.17 |
| DE, kcal/kg ³ | | +84 | +203.5 | +234.5 | |

^{a,b,c}Mean in the same row with different superscripts differ (P < 0.05)
¹ADF: acid detergent fiber
²NDF: neutral detergent fiber
³DE: The difference in digestible energy (kcal/kg) relative to the negative control diet.

### Fecal Ammonia Emissions:

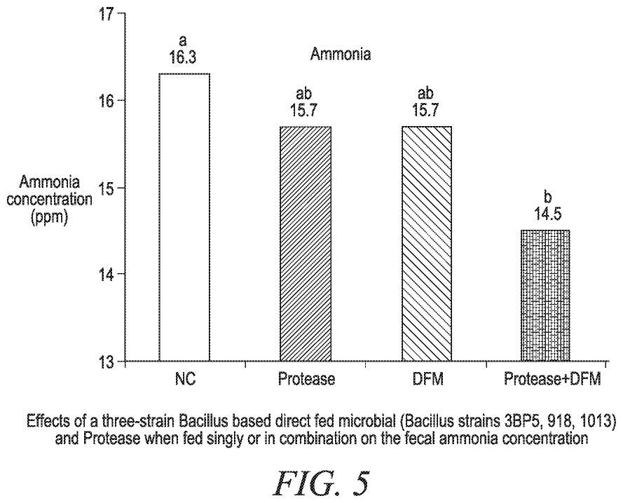

The addition of the protease+DFM combination to a corn based diet significantly decreased fecal ammonia emissions compared to the negative control (FIG. 5). While the DFMs and protease when fed singly numerically decreased fecal ammonia emissions compared to the control, combining the protease and DFMs together resulted in the greatest reduction (11% reduction compared to the negative control) in fecal ammonia concentration.

### PKY1312—Example 4

### Effects of a Three-Strain Bacillus Based Direct Fed Microbial (Bacillus Strains 3BP5, 918, 1013) and Protease Combination on the Growth Performance of Pigs Fed Corn Based Diets

### Materials and Methods

### Experimental Design

A total of 180 pigs (BW=23.15±2.66 kg) of equal barrows and gilts were allotted to 1 of 3 dietary treatments: 1) Negative control (NC) 2) NC+DFM and 3) NC+Protease+DFM (Table 4.1). There were 4 pigs per pen with 15 pens (8 gilt pens and 7 barrow pens) per treatment. Pigs were given ad libitum access to feed and water. Diets were formulated to meet or exceed NRC 2012 nutrient and energy requirements and 3 phases were formulated (Table 4.2). The calculated chemical composition of phase 2 and 3 diets is outlined in Table 4.3. Phase 1, 2, and 3 were fed for 41, 45, and 23 days, respectively for a total experimental period of 109 days. Pigs and feeders were weighed weekly to calculate average daily gain (ADG), average daily feed intake (ADFI) and feed conversion ratio (FCR).

TABLE 4.1
Experimental diets identification

| | | DFM, CFU or FU*/g | Enzyme, |
|---|---|---|---|
| Treatment | Description | of feed | U/kg of feed |
| 1 | Control, basal (NC) | N/A | N/A |
| 2 | NC + DFM¹ | 1.5 × 10⁵ | N/A |
| 3 | NC + DFM + Protease² | 1.5 × 10⁵ | 6000 |

¹3 strains of Bacillus: Bacillus strains 3BP5, 918 and 1013
²Protease: Bacillus amyloliquefaciens protease P3000

TABLE 4.2
Ingredient composition (%) of experimental diets, as-fed basis

| | Phase 1 | | | Phase 2 | | | Phase 3 | | |
|---|---|---|---|---|---|---|---|---|---|
| Item, % | NC | DFM | DFM + P | NC | DFM | DFM + P | NC | DFM | DFM + P |
| Corn | 43.39 | 43.39 | 43.39 | 45.41 | 45.41 | 45.41 | 55.43 | 55.43 | 55.43 |
| Corn DDGS | 25.00 | 25.00 | 25.00 | 45.22 | 45.22 | 45.22 | 15.00 | 15.00 | 15.00 |
| Soybean meal | 19.00 | 19.00 | 19.00 | 14.12 | 14.12 | 14.12 | 11.00 | 11.00 | 11.00 |
| Soybean oil | 0.50 | 0.50 | 0.50 | 0.50 | 0.50 | 0.50 | 1.00 | 1.00 | 1.00 |
| Vitamin premix¹ | 0.15 | 0.15 | 0.15 | 0.15 | 0.15 | 0.15 | 0.15 | 0.15 | 0.15 |
| Mineral premix² | 0.15 | 0.15 | 0.15 | 0.15 | 0.15 | 0.15 | 0.15 | 0.15 | 0.15 |
| Salt | 0.35 | 0.35 | 0.35 | 0.35 | 0.35 | 0.35 | 0.35 | 0.35 | 0.35 |
| Limestone | 1.10 | 1.10 | 1.10 | 0.81 | 0.81 | 0.81 | 0.66 | 0.66 | 0.66 |
| L-lysine HCL | 0.25 | 0.25 | 0.25 | 0.17 | 0.17 | 0.17 | 1.95 | 1.95 | 1.95 |
| L-threonine | 0.10 | 0.10 | 0.10 | — | — | — | 0.10 | 0.10 | 0.10 |
| Soybean hulls | 5.00 | 5.00 | 5.00 | 5.04 | 5.04 | 5.04 | 8.00 | 8.00 | 8.00 |
| Wheat | 5.00 | 5.00 | 5.00 | 8.07 | 8.07 | 8.07 | 8.00 | 8.00 | 8.00 |
| middlings³ | | | | | | | | | |
| NC⁴ | 0.01 | — | — | 0.01 | — | — | 0.01 | — | — |
| DFM⁴ | — | 0.01 | — | — | 0.01 | — | — | 0.01 | — |
| DFM + | — | — | 0.025 | — | — | 0.025 | — | — | 0.025 |
| Protease⁵ | | | | | | | | | |
| DFM⁶ | — | 0.006 | 0.006 | — | 0.006 | 0.006 | — | 0.006 | 0.006 |

¹Composition: Supplied per kg of diet: vitamin A, 6,600 IU; vitamin D₃, 880 IU; vitamin E, 44 IU; vitamin K (menadione sodium bisulfate complex), 6.4 mg; thiamin, 4.0 mg; riboflavin, 8.8 mg; pyridoxine, 4.4 mg; vitamin B12, 33 μg; folic acid, 1.3 mg; niacin, 44 mg.
²Composition: Supplied per kg of diet Zn, 131 mg as ZnO; Fe, 131 mg as FeSO₄•H₂O; Mn 45 mg, as MnO; Cu, 13 mg as CuSO₄•H₂O; I, 1.5 mg as CaIO₆; Co, 0.23 mg as CoCO₃; Se, 0.28 mg as Na₂O₃Se.
²Supplied per kg of diet: Zn, 131 mg as ZnO; Fe, 131 mg as FeSO₄•H₂O; Mn 45 mg, as MnO; Cu, 13 mg as CuSO₄•5H₂O; I, 1.5 mg as CaIO₆; Co, 0.23 mg as CoCO₃; Se, 0.28 mg as Na₂O₃Se.
³Contain less than 9.5% fines
⁴Supplemented at 100 g per metric ton.
⁵Supplemented at 250 g per metric ton.
⁶DFM = direct-fed microbial; included at 60 g per metric ton.

TABLE 4.3
Calculated chemical composition (%) of experimental
diets in phase 2 and 3, DM¹-basis

| | Phase 2 | | | Phase 3 | | |
|---|---|---|---|---|---|---|
| Item, % | NC | DFM | DFM + P | NC | DFM | DFM + P |
| Dry Matter, % | 88.12 | 88.41 | 88.62 | 88.68 | 88.39 | 88.55 |
| Gross energy, | 4,558 | 4,539 | 4,532 | 4,490 | 4,494 | 4,524 |
| kcal/kg | | | | | | |
| Crude protein, % | 3.47 | 3.48 | 3.36 | 2.61 | 2.93 | 2.76 |
| Carbon, % | 45.98 | 45.93 | 45.78 | 45.40 | 45.46 | 45.76 |
| Sulfur, % | 0.36 | 0.36 | 0.35 | 0.27 | 0.28 | 0.25 |
| NDF, %² | 21.30 | 21.32 | 21.52 | 20.42 | 20.60 | 20.84 |

¹DM = dry matter
²NDF = neutral detergent fiber

### Statistical Analysis

Data were analysed using the MIXED procedure of SAS (SAS Institute Inc., Cary, N.C.). For growth performance, pen was used as the experimental unit. For all data, the model included treatment as a fixed effect and pen as a random effect. Outliers were determined using the UNIVARIATE procedure. Significance was determined at P<0.05.

### Results

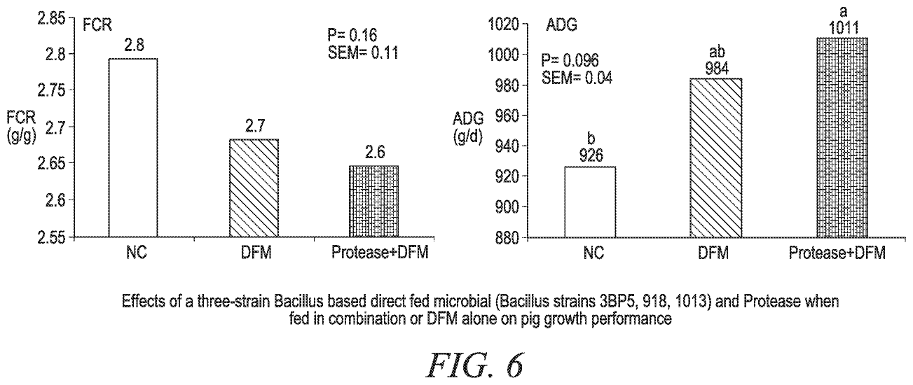

Pigs fed the protease+DFM treatment tended to have higher ADG compared to the control (P=0.09). Compared to feeding the DFM alone, feeding the DFM in combination resulted in higher ADG and lower FCR (FIG. 6).

### Example 5

### Effects of a Three-Strain Bacillus Based Direct Fed Microbial (Bacillus Strains 3BP5, 918, 1013) and Protease when Fed Singly or in Combination on the Growth Performance and Total Tract Digestibility of Nutrients in Pigs Fed Corn Based Diets

### Materials and Methods

A total of 64 pigs (Danbred DB90, dams×Agroceres PIC 337, sires) with an initial body weight (BW) of 25.96±0.57 kg were utilized in a 42 day study. The animals were allotted in 32 pens with 2 pigs each, which were comprised of equalized sex ratios with 8 reps/treatments. The pen was considered the experimental unit of study. Pigs were given ad libitum access to feed and water. Diets were formulated to meet or exceed NRC 2012 nutrient and energy requirements (Table 5.1) and pens were randomly allotted to one of four treatments (Table 5.2).

TABLE 5.1
Nutritional composition of basal feed.

| Items | % |
|---|---|
| Corn | 64.70 |
| Soybean meal | 28.10 |
| Soybean oil | 3.38 |
| Dicalcium phosphate | 0.85 |
| Limestone | 1.05 |
| Salt | 0.47 |
| Mineral premix | 0.10 |
| Vitamin premix | 0.05 |
| L-Lysine HCL ( | 0.415 |
| DL-Methionine | 0.17 |
| L-Threonine | 0.15 |
| L-Tryptophan | 0.015 |
| Copper sulphate | 0.05 |
| White Kaolin | 0.50 |
| Total | 100.00 |
| Calculated composition | |
| CP (%) | 18.40 |
| ME (kcal/kg) | 3400 |
| Lys. Dig. (%) | 1.15 |

TABLE 5.2
Experimental diets identification

| | | DFM, CFU or FU*/g | Enzyme, |
|---|---|---|---|
| Treatment | Description | of feed | U/kg of feed |
| 1 | Control, basal (NC) | N/A | N/A |
| 2 | NC + DFM¹ | 1.5 × 10⁵ | N/A |
| 3 | NC + Protease² | N/A | 5000 |
| 4 | NC + DFM + Protease | 1.5 × 10⁵ | 5000 |

¹3 strains of Bacillus: Bacillus strains 3BP5, 918 and 1013
²Protease: Bacillus amyloliquefaciens protease P3000

### Growth Performance:

Body weight and feed consumption is measured weekly to monitor the average daily gain (ADG), average daily feed intake (ADFI) and feed conversion ratio (FCR).

### Results

### Growth Performance:

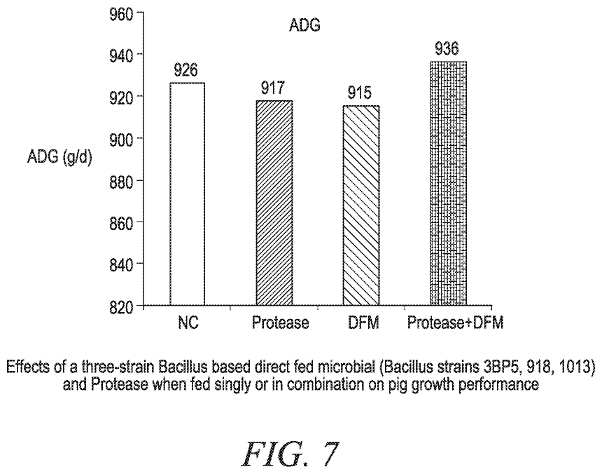

There was an improvement in the ADG of pigs fed corn-based diets when DFM+protease was added to the diet compared to feeding the DFM or protease individually (FIG. 7).

### Example 6

### In-Vitro Evaluation of the Effects of Single or Multiple Strains of Direct-Fed Microbials (DFMs) and Protease on their Ability to Solubilise Protein from Wheat or Soybean Meal Based Substrate Fed to Pigs

### Materials and Methods

A total of 8 ileal cannulated barrows (initial BW 30 kg) were fed one of 2 experimental diets in an 8×2 Latin square design. There were two consecutive periods each consisting of 7 days. The semi-purified diets, consisting mostly of wheat or SBM were fed for 7 days during each period with 5 days for adaptation and 2 days for ileal collection. Pigs were randomly allotted to 1 of 2 experiment diets at the beginning of the first period (d 0) and changed to the second diet at the beginning of the second period (d 7). The diets contained chromic oxide which was used to calculate the apparent ileal digestibility of crude protein, and samples from the pig with apparent ileal digestibility of crude protein closest to the population average were selected for the in-vitro study. Pigs were housed in an environmentally-controlled room. Each pen was equipped with a one-sided, stainless steel self-feeder and a nipple drinker that allowed pigs access to feed and water ad libitum. The basal diet was formulated to meet or exceed the nutrient requirements for growing pigs of this age (Table 6.1) as recommended by the NRC (2012).

TABLE 6.1
Example of basal diet composition
for pigs 30 kg body weight

| | | SBM, |
|---|---|---|
| | Wheat | 46% |
| Wheat | 93.10 | — |
| SBM, 46% | — | 35.00 |
| Soybean oil | 4.00 | 4.00 |
| Corn starch | — | 38.25 |
| Sucrose | — | 20.00 |
| Limestone | 1.05 | 0.70 |
| Dicalcium P | 0.75 | 0.95 |
| Salt | 0.40 | 0.40 |
| Chromic oxide | 0.40 | 0.40 |
| Vitamin-min. | 0.30 | 0.30 |
| premix | | |
| Energy and | | |
| nutrients | | |
| NE, Kcal/kg | 2630 | 3064 |
| CP, % | 10.17 | 16.10 |
| Ca, % | 0.59 | 0.59 |
| P, % | 0.42 | 0.43 |
| Digestible P, % | 0.27 | 0.27 |

Upon collection of the digesta from the pigs, it was immediately frozen at −20° C. and subsequently freeze dried. The freeze dried digesta samples were then used in an in-vitro incubation with the DFM and protease either singly or in combination. The DFMs used in the study included single strains of Bacillus pumilis (8G-134), Bacillus licheniformis (AEE3), Lactobacillus reuteri (ANC1) and a 3-strain Bacillus combination consisting of 3 strain of B. subtilis (918, 1013 and 3BP5).

### Cultivating Anaerobic Bacteria

Overnight cultures of Lactobacillus reuteri (ANC1) were inoculated by transferring one bead with the cryo-preserved bacteria adhering to the surface into a 13 mL tube (Sarstedt 62.515.006) containing 3 mL MRS (deMan, Rogosa and Sharpe) medium (OXOID, CMS359) prepared and sterilized according to the manufacturer's instructions. The tubes were place in a tightened anaerobic jar (Anaerocult®) holding two activated anaerobic gas generating sachets (Oxoid AnaeroGen 2.5 L, Thermo Scientific). An Anaerotest strips (Merck 115112) was inserted in the jar and indicated the atmosphere was anaerobic (white color) during the incubation. The bacteria were incubated for 18 hour at 37° C. with 50 rpm shaking.

A subculture was made by transferring 30 μL of overnight culture to 3 mL of fresh MRS media in new 13 mL tubes (Sarstedt 62.515.006). The tubes place in the tight anaerobic jar (Anaerocult®) together with a fresh, activated anaerobic gas generating sachet (Oxoid AnaeroGen 2.5 L, Thermo Scientific). The subculture was incubated at 37° C. with 50 rpm shaking until the cultures reached an optical density at 600 nm (OD600) between 0.2-0.4. The culture was diluted with MRS media to OD600=0.1 and subsequently diluted 10 times with 100 mM MES (2-(N-morpholino)ethanesulfonic acid) buffer, pH 6.2. The treatment of the ileal samples were initiated immediately hereafter.

### Cultivating Aerobic Bacteria

Overnight cultures of B. subtilis (3BP5, 918 and 1013), B. licheniformis (AEE3), and B. pumilis (8G-134) were inoculated by transferring one bead with the cryo-preserved bacteria adhering to the surface into a 13 mL tube (Sarstedt 62.515.006) containing 3 mL of TSB (Tryptic Soy Broth) medium (Merck 1.05459) prepared and sterilized according to the manufacturer's instructions. The tubes were incubated for 18 hours with shaking (200 rpm). The B. pumilis strain was incubated at 32° C. and the remaining of the strains were incubated at 37° C.

A subculture was made by transferring 300 μL overnight culture to 30 mL of fresh TSB media in 250 mL glass flasks with three baffles. Under contentious shaking the B. pumilis strain was incubated at 32° C. and the remaining of the strains were incubated at 37° C. until a OD600 value in the range of 0.3 and 0.7 was obtained. The culture was diluted with TSB media to OD600=0.1 and subsequently diluted 10 times with 100 mM MES buffer, pH 6.2. The treatment of the ileal samples were initiated immediately hereafter.

Treatment of Ileal Samples with a Combination of Bacteria and Protease

The freeze-dried ileal samples were treated with the individual bacterial cultures either singly or in combination with protease. All treatments were tested in doublets. Between 0.097-0.103 g freeze dried ileal sample were transferred to a 2 mL microcentrifuge tube (Eppendorf). 850 μL of 100 mM MES buffer, pH 6.2 was added together with 20 μL of 50 mM Sodium Acetate buffer, pH 5.0 or protease (B. amyloliquefaciens protease P3000, 55 U/mL) in 50 mM Sodium Acetate buffer, pH 5.0. The samples were mixed thoroughly until all material was wetted. 30 μL 100 mM MES buffer, pH 6.2 or bacterial culture diluted in MES buffer were added. For the 3-strain Bacillus combination (strain 918, 1013 and 3BP5) 10 μL for each of the three strain was added (given a total volume of 30 μL). All tubes were incubated for 2 hours at 37° C. with shaking (1150 rpm) in a Thermomixer (Eppendorf). After 2 hours of incubation the samples were transferred to ice and left to stand for 5 min. The tubes were centrifuged at 17000×g for 2 min. The supernatant was recovered and filtered using AcroPrep™ Advance Filter Plates (3 μm glass fiber/0.2 μm Supor® membrane) by centrifugation. The samples were stored at −20° C. until further analysis.

### Protein Quantification

The protein in solution was quantified using the Quant-iT Protein Assay Kit (Molecular probes Q33210) against a BSA standard curve (0-300 μg/mL) using the protocol provided by the manufacture with a sample volume of 10 μL.

### Results

### Protein Solubilisation:

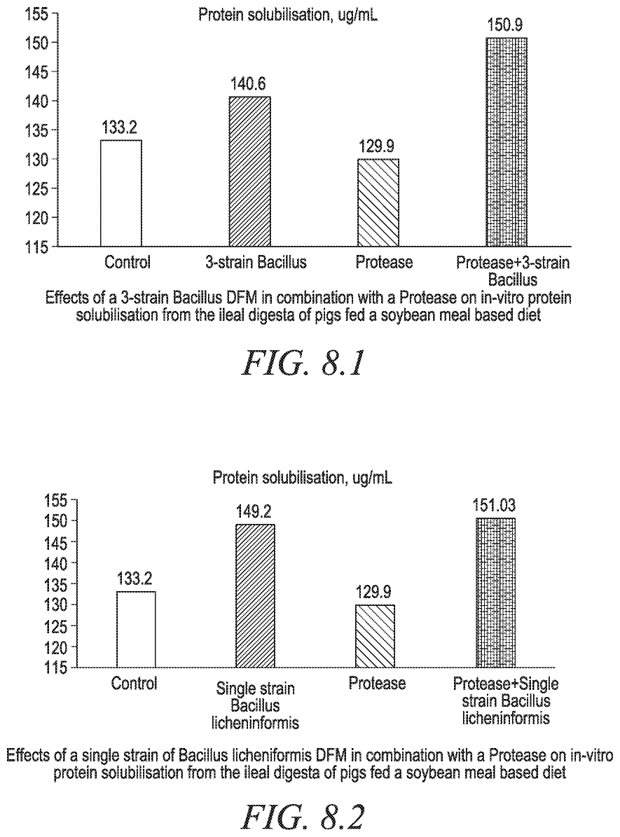

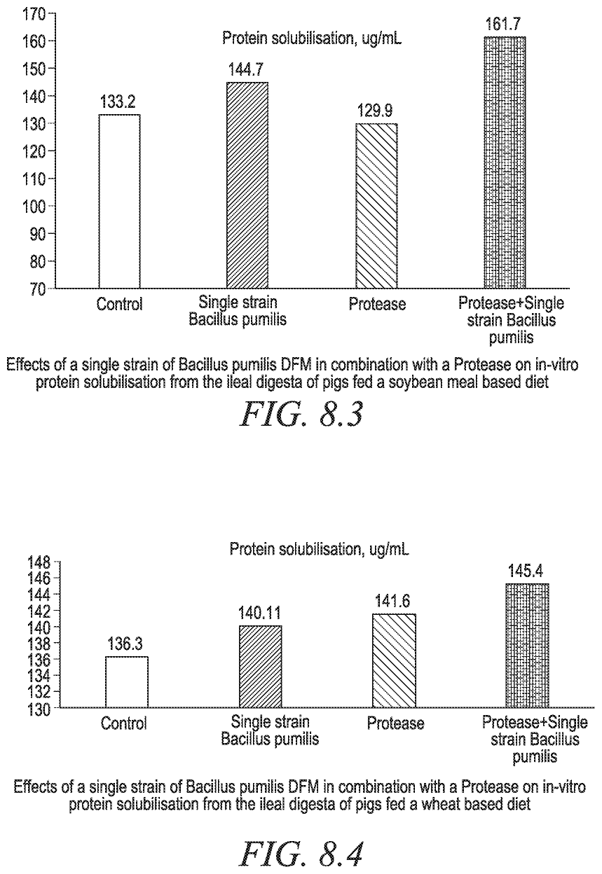

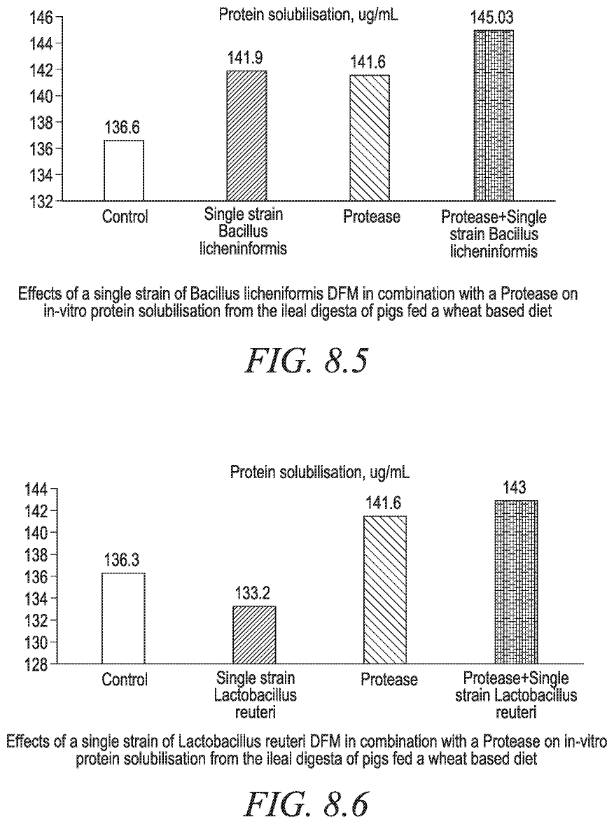

Combining a 3-strain combination of Bacillus subtilis with a protease increased the solubilisation of protein from soybean meal based pig pig ileal digesta compared to the individual DFMs or protease component alone (FIG. 8.1).

Combining a single strain of Bacillus licheniformis with a protease also resulted in greater protein solubilisation from the ileal digesta of pigs fed a soybean meal based diet than the individual components of protease or DFM alone (FIG. 8.2).

Combining a single strain of Bacillus pumilis with a protease also resulted in greater protein solubilisation from the ileal digesta of pigs fed a soybean meal based diet than the individual components of protease or DFM alone (FIG. 8.3).

Combining a single strain of Bacillus pumilis with a protease resulted in greater protein solubilisation from the ileal digesta of pigs fed a wheat based diet than the individual components of protease or DFM alone (FIG. 8.4).

Combining a single strain of Bacillus licheniformis with a protease resulted in greater protein solubilisation from the ileal digesta of pigs fed a wheat based diet than the individual components of protease or DFM alone (FIG. 8.5).

Combining a single strain of Lactobacillus reuteri with a protease resulted in greater protein solubilisation from the ileal digesta of pigs fed a wheat based diet than the individual components of protease or DFM alone (FIG. 8.6).

### Example 7

### Effects of a Three-Strain Bacillus Based Direct Fed Microbial (Bacillus Strains 3BP5, 918, 1013) and Protease when Fed in Combination on the Carcass Characteristics of Pigs Fed Corn Based Diets

### Materials and Methods

The experiment was conducted according to the Animal Experimental and Ethics Committee Regulations/Laboratory Practise Codes in the Netherlands. The basal diet, as fed, was formulated to meet or exceed the nutrient requirements for growing pigs of this age (Table 7.1) as recommended by the NRC (2012), except for net energy (NE) which was reduced by approximately 200 kcal/kg. The basal diet was divided into portions which were then treated with the enzyme and direct fed microbial (DFM) combination as identified in Table 7.2. During feed mixing, the mixer was flushed to prevent cross contamination of diets. Samples were collected from each treatment diet from the beginning, middle, and end of each batch and blended together to confirm enzyme activities and DFM counts in feed.

TABLE 7.1
Example of basal diet composition for
pigs 23-116 kg bodyweight

| | Phase 1 | Phase 2 | Phase 3 |
|---|---|---|---|
| Ingredients (% as | (23-50 | (50-82 | (82-116 |
| fed) | kg) | kg) | kg) |
| Maize | 62.67 | 63.66 | 63.57 |
| Soybean oil | 0.01 | 0.01 | 0.06 |
| Wheat middlings | 14.88 | 14.90 | 19.90 |
| Premix 0.4% | 0.40 | 0.40 | 0.40 |
| Salt | 0.43 | 0.31 | 0.31 |
| Prem. Vitamin AD3E | 0.10 | 0.10 | 0.10 |
| Soybean hulls | 2.00 | 7.00 | 7.00 |
| >36% CF | | | |
| Vitamins/trace-elem. | 0.10 | 0.10 | 0.10 |
| Lysine-HCl (L 79%) | 0.40 | 0.31 | 0.27 |
| Methionine (DL 99%) | 0.05 | 0.01 | 0.00 |
| Threonine (L 98%) | 0.09 | 0.06 | 0.05 |
| Limestone | 1.09 | 0.94 | 0.70 |
| SBM > 48% CP | 17.45 | 11.87 | 7.21 |
| Phytase | 0.33 | 0.33 | 0.33 |
| Moisture | 128.37 | 128.69 | 129.51 |
| Crude Protein | 161.82 | 139.34 | 123.61 |
| Ash | 43.49 | 39.61 | 36.50 |
| Crude Fibre | 38.35 | 54.98 | 57.72 |
| Sugar | 28.02 | 25.37 | 25.23 |
| Crude Fat_AH | 35.54 | 35.24 | 36.48 |
| STRCH_AM | 424.54 | 430.94 | 440.10 |
| NE_Swine | 2282.07 | 2263.59 | 2258.34 |
| SID_LYSs | 9.74 | 7.76 | 6.44 |
| SID_METs | 2.80 | 2.12 | 1.83 |
| SID_M + Cs | 5.14 | 4.18 | 3.72 |
| SID_THRs | 5.77 | 4.70 | 4.01 |
| SID_TRPs | 1.52 | 1.24 | 1.07 |
| SID_ARGs | 9.34 | 7.70 | 6.57 |
| SID_ILEs | 5.55 | 4.59 | 3.85 |
| SID_VALs | 6.52 | 5.55 | 4.88 |
| SID_HISs | 3.89 | 3.32 | 2.94 |
| SID_ALAs | 7.21 | 6.34 | 5.74 |
| SID_ASPs | 12.67 | 10.21 | 8.31 |
| SID_GLUs | 25.89 | 21.88 | 19.44 |
| SID_GLYs | 5.59 | 4.81 | 4.24 |
| SID_LEUs | 12.17 | 10.63 | 9.47 |
| SID_PHEs | 6.70 | 5.65 | 4.86 |
| SID_PROs | 9.00 | 7.91 | 7.26 |
| SID_SERs | 6.88 | 5.80 | 5.02 |
| SID_TYRs | 4.93 | 4.19 | 3.62 |
| Ca | 5.30 | 4.83 | 3.86 |
| P | 4.00 | 3.75 | 3.92 |
| Na | 1.81 | 1.34 | 1.34 |
| Cl | 3.91 | 3.01 | 2.94 |

TABLE 7.2
Experimental diets identification

| | | DFM, CFU or | Enzyme, |
|---|---|---|---|
| | | FU*/g of | U/kg |
| Treatment | Description | Feed | of feed |
| 1 | Basal Negative | N/A | N/A |
| | Control | | |
| 2 | NC + DFM¹ + | 1.5 × 10⁵ | 5000 |
| | Protease² | | |

¹3 strains of Bacillus: Bacillus strains 3BP5, 918 and 1013
²Protease: Bacillus amyloliquefaciens protease P3000
The experiment is planned and conducted to correspond to growing phase (≤23 to ~116 kg body weight).

### Experimental Design

A total of 180 growing pigs [Great York×Landrace] with an average body weight of 23 kg were used in 96-113 day experiment. Pigs were randomly allotted to 2 experiment diets according to their initial body weight. There were 10 replicate pens per treatment with 9 pigs per pen. Barrows and gilts were separated with five pens of barrows and five pens of gilts in each treatment. All pigs are housed in an environmentally-controlled room. Each pen is equipped with a one-sided, stainless steel self-feeder and a nipple drinker that pigs are allowed access to feed and water ad libitum.

### Carcass Characteristics Measurement and Analysis

On the final day of the experiment, when pigs weighed approximately 116 kg bodyweight (at either 96 or 116 days), pigs were sacrificed and carcass quality was determined from the slaughter data. Back fat depth (mm) was measured at the P2 site which is located 65 mm from the dorsal mid-line at the level of the last rib with a probe. Meat percentage, a measure which is routinely used to estimate the leanness of the carcass was calculated as follows:

% Meat={8.588+(0.465×carcass weight)+(3.005×loin muscle area)−(21.896×Fat depth)}/carcass weight

### Statistical Analysis

All data were subjected to the statistical analysis as a randomized complete block design using the Mixed procedures of SAS (SAS Inst. Inc., Cary, N.C.), and the pen was used as the experimental unit. Data was deemed significant at P<0.05.

### Results

Supplementation of a corn-based diet with a combination of a DFM (Bacillus) and a protease significantly improved meat percentage and back-fat depth (P<0.05) compared to the negative control basal diet without any additives (Table 7.3).

TABLE 7.3
Effects of a three-strain Bacillus based direct fed
microbial (Bacillus strains 3BP5, 918, 1013) and Protease
when fed in combination on carcass characteristics

| | | DFM + | | |
|---|---|---|---|---|
| | NC | Protease | SEM | P-value |
| Meat % | 60.5^{b} | 61.0^{a} | 0.15 | 0.030 |
| Back-fat depth, | 11.7^{a} | 10.9^{b} | 0.24 | 0.034 |
| mm | | | | |

^{a,b}Mean in the same row with different superscripts differ (P < 0.05)

### Example 8

### In-Vitro Evaluation of the Effects of a Three-Strain Bacillus Based Direct-Fed Microbial (Bacillus Strains 3BP5, 918, 1013) and Protease when Applied Singly or in Combination on the Solubilisation of Protein from Wheat or Soybean Meal-Based Diets Fed to Grower Pigs

### Materials and Methods

A total of 8 ileal cannulated barrows (initial BW 30 kg) were fed one of 2 experimental diets in an 8×2 Latin square design. There were two consecutive periods each consisting of 7 days. The semi-purified diets, consisting mostly of wheat or SBM were fed for 7 days during each period with 5 days for adaptation and 2 days for ileal collection. Pigs were randomly allotted to 1 of 2 experiment diets at the beginning of the first period (d 0) and changed to the second diet at the beginning of the second period (d 7). The diets contained chromic oxide which was used to calculate the apparent ileal digestibility of crude protein, and samples from the pig with apparent ileal digestibility of crude protein closest to the population average were selected for the in-vitro study. Pigs were housed in an environmentally-controlled room. Each pen was equipped with a one-sided, stainless steel self-feeder and a nipple drinker that allowed pigs access to feed and water ad libitum. The basal diet was formulated to meet or exceed the nutrient requirements for growing pigs of this age (Table 8.1) as recommended by the NRC (2012).

TABLE 8.1
Example of basal diet composition
for pigs 30 kg body weight

| | | SBM, |
|---|---|---|
| | Wheat | 46% |
| Wheat | 93.10 | — |
| SBM, 46% | — | 35.00 |
| Soybean oil | 4.00 | 4.00 |
| Corn starch | — | 38.25 |
| Sucrose | — | 20.00 |
| Limestone | 1.05 | 0.70 |
| Dicalcium P | 0.75 | 0.95 |
| Salt | 0.40 | 0.40 |
| Chromic oxide | 0.40 | 0.40 |
| Vitamin-min. | 0.30 | 0.30 |
| premix | | |
| Energy and | | |
| nutrients | | |
| NE, Kcal/kg | 2630 | 3064 |
| CP, % | 10.17 | 16.10 |
| Ca, % | 0.59 | 0.59 |
| P, % | 0.42 | 0.43 |
| Digestible P, % | 0.27 | 0.27 |

Upon collection of the digesta from the pigs, it was immediately frozen at −20° C. and subsequently freeze dried. The freeze dried digesta samples were then used in an in-vitro incubation with the DFM and protease either singly or in combination. The DFMs used in the study included a 3-strain Bacillus combination consisting of 3 strain of B. subtilis (3BP5, 918 and 1013)( ).

### Cultivating Aerobic Bacteria

Overnight cultures of B. subtilis (3BP5, 918 and 1013) were inoculated by transferring one bead with the cryo-preserved bacteria adhering to the surface into a 13 mL tube (Sarstedt 62.515.006) containing 3 mL of TSB (Tryptic Soy Broth) medium (Merck 1.05459) prepared and sterilized according to the manufacturer's instructions. The tubes were incubated for 18 hours with shaking (200 rpm). All Bacillus strains were incubated at 37° C. A subculture was made by transferring 300 μL overnight culture to 30 mL of fresh TSB media in 250 mL glass flasks with three baffles. Under contentious shaking all Bacillus strains were incubated at 37° C. until a OD600 value in the range of 0.3 and 0.7 was obtained. The culture was diluted with TSB media to OD600=0.1 and subsequently diluted 10 times with 100 mM MES buffer, pH 6.2. The treatment of the ileal samples were initiated immediately hereafter.

Treatment of Ileal Samples with a Combination of Bacteria and Protease

The freeze-dried ileal samples were treated with the individual bacterial cultures either singly or in combination with protease. All treatments were tested in doublets. Between 0.097-0.103 g freeze dried ileal sample were transferred to a 2 mL microcentrifuge tube (Eppendorf). 850 μL of 100 mM MES buffer, pH 6.2 was added together with 20 μL of 50 mM Sodium Acetate buffer, pH 5.0 or protease (B. amyloliquefaciens protease P3000, 55 U/mL) in 50 mM Sodium Acetate buffer, pH 5.0. The samples were mixed thoroughly until all material was wetted. 30 μL 100 mM MES buffer, pH 6.2 or bacterial culture diluted in MES buffer were added. For the 3-strain Bacillus combination (strain 918, 1013 and 3BP5) 10 μL for each of the three strain was added (given a total volume of 30 μL). All tubes were incubated for 2 hours at 37° C. with shaking (1150 rpm) in a Thermomixer (Eppendorf). After 2 hours of incubation the samples were transferred to ice and left to stand for 5 min. The tubes were centrifuged at 17000×g for 2 min. The supernatant was recovered and filtered using AcroPrep™ Advance Filter Plates (3 μm glass fiber/0.2 μm Supor® membrane) by centrifugation. The samples were stored at −20° C. until further analysis.

### Protein Quantification

The protein in solution was quantified using the Quant-iT Protein Assay Kit (Molecular probes Q33210) against a BSA standard curve (0-300 μg/mL) using the protocol provided by the manufacture with a sample volume of 10 μL.

### Results

Single application of protease or DFM numerically increased the amount of protein solubilised from the wheat and soybean meal samples compared to the negative control without additives. However, when the protease and the 3 strain Bacillus DFM were combined there was an increase in the amount of protein solubilised from the wheat and soybean meal samples compared to the control and the protease or DFM alone (Table 8.3).

TABLE 8.3
Effects of a three-strain Bacillus based direct
fed microbial (Bacillus strains 3BP5, 918, 1013)
and Protease when applied singly or in combination
on the solubilisation of protein from wheat or soybean
meal-based diets fed to growing pigs

| Total Protein, | | | | DFM + |
|---|---|---|---|---|
| μg/mL | NC | Protease | DFM | Protease |
| Wheat | 1063 | 1759.7 | 1408.7 | 2022.1 |
| SBM 46 | 729.6 | 1554.9 | 840.5 | 1634.5 |

1. A feed additive composition consisting essentially of a direct-fed microbial comprising one or more bacterial strains in combination with at least one protease.

2. The feed additive composition according of claim 1 wherein the direct-fed microbial is an antipathogen direct-fed microbial.

3. The feed additive composition of claim 1, wherein the direct-fed microbial comprises at least three bacterial strains selected from the group consisting of: Lactobacillus, Lactococcus, Streptococcus, Bacillus, Pediococcus, Enterococcus, Leuconostoc, Carnobacterium, Propionibacterium, Bifidobacterium, Clostridium and Megasphaera and combinations thereof.

4. The feed additive composition of claim 3 wherein the direct-fed microbial comprises at least three bacterial strains selected from the group consisting of: Bacillus subtilis, Bacillus licheniformis, Bacillus pumilus, Bacillus amyloliquefaciens, Enterococcus, Enterococcus spp, and Pediococcus spp, Lactobacillus spp, Bifidobacterium spp, Lactobacillus acidophilus, Pediococsus acidilactici, Lactococcus lactis, Bifidobacterium bifidum, Propionibacterium thoenii, Lactobacillus farciminus, Lactobacillus rhamnosus, Clostridium butyricum, Bifidobacterium animalis ssp. animalis, Lactobacillus reuteri, Bacillus cereus, Lactobacillus salivarius ssp. salivarius, Megasphaera elsdenii, Propionibacteria sp and combinations thereof.

5. The feed additive composition of claim 1, wherein the direct-fed microbial comprises Bacillus subtilis strains 3BP5 (NRRL B-50510); 918 (NRRL B-50508), and 1013 (NRRL B-50509).

6. The feed additive composition of claim 1, wherein the direct-fed microbial is in the form of an endospore.

7. The feed additive composition of claim 5 wherein the direct-fed microbial is in the form of an endospore.

8. The feed additive composition of claim 1, wherein the protease is a subtilisin, a bacillolysin, an alkaline serine protease, a keratinase or a Nocardiopsis protease.

9. The feed additive composition of claim 6 wherein the protease is a subtilisin, a bacillolysin, an alkaline serine protease, a keratinase or a Nocardiopsis protease.

10. The feed additive composition of claim 1, wherein the protease is a subtilisin from Bacillus amyloliquefaciens.

11. The feed additive composition of claim 6 wherein the protease is a subtilisin from Bacillus amyloliquefaciens.

12. The feed additive composition of claim 1, wherein the protease is present at a dosage of 1000 PU/g feed additive composition to 200,000 PU/g feed additive composition.

13. The feed additive composition of claim 6 wherein the protease is present at a dosage of 1000 PU/g feed additive composition to 200,000 PU/g feed additive composition.

14. The feed additive composition of claim 1, wherein the DFM is present at a dosage of 1×10³ CFU/g feed additive composition to 1×10¹³ CFU/g feed additive composition.

15. The feed additive composition of any of claim 6 wherein the DFM is present at a dosage of 1×10³ CFU/g feed additive composition to 1×10¹³ CFU/g feed additive composition.

16. A method for improving the performance of a subject or for improving digestibility of a raw material in a feed (e.g. nutrient digestibility, such as amino acid digestibility), or for improving nitrogen retention, or for improving the subjects resistance to necrotic enteritis or for improving feed conversion ratio (FCR) or for increasing the carcass or meat yield or for improving body weight gain in a subject or for improving feed efficiency in a subject or for modulating (e.g. improving) the immune response of the subject, or for promoting the growth of beneficial bacteria in the gastrointestinal tract of a subject or for reducing populations of pathogenic bacteria in the gastrointestinal tract of a subject, or for reducing nutrient excretion in manure, or for reducing the production of ammonia in manure, or for improving the digestibility or utilization of dietary hemicellulose or fibre, which method comprising administering a direct fed microbial comprising one or more bacterial strains in combination with at least one protease.

17. A kit comprising the feed additive composition of claim 1 and instructions for administration.

18. A method of preparing a feed additive composition, comprising admixing a direct fed microbial comprising one or more bacterial strains in combination with at least one protease and packaging.

19. A feed comprising the feed additive composition of claim 1.

20. A feed comprising the feed additive composition of claim 6.

21. A premix comprising a feed additive composition of claim 1 and at least one mineral and/or at least one vitamin.
